(19) United States
(12) Patent Application Publication
(10) Pub. No.: US 2006/0214996 A1
(43) Pub. Date: Sep. 28, 2006

(54) Liquid droplet discharge head and method of manufacturing the liquid droplet discharge head

(76) Inventors: Hirokazu Matsuzaki, Kanagawa (JP); Shinji Seto, Kanagawa (JP); Torahiko Kanda, Kanagawa (JP); Katsuhiro Notsu, Kanagawa (JP); Shigeru Umehara, Kanagawa (JP)

Correspondence Address: FILDES & OUTLAND, P.C., 20916 MACK AVENUE, SUITE 2, GROSSE POINTE WOODS, MI, 48236, US

(21) Appl. No.: 11/347,605

(22) Filed: Feb. 3, 2006

(30) Foreign Application Priority Data
Mar. 24, 2005 (JP) 2005-087155
Aug. 15, 2005 (JP) 2005-237484

(51) Int. Cl. B41J 2/045

(52) U.S. Cl. 347/71

(57) ABSTRACT

A method of manufacturing a liquid droplet discharge head including nozzles that discharge liquid droplets, pressure chambers that are communicated with the nozzles and filled with liquid droplets, a diaphragm that configures part of the pressure chambers, and piezoelectric member groups that are configured by joining, to the surface of the diaphragm, piezoelectric plates that form groove portions and are processed in a matrix, with the piezoelectric member groups including piezoelectric elements that cause the diaphragm to be displaced as a result of a voltage being applied to the piezoelectric elements, the method comprising: processing the piezoelectric plates in a matrix to prepare the piezoelectric member groups; and joining the piezoelectric member groups to the diaphragm in a state where mutual boundaries of the piezoelectric member groups have been fitted together and with a predetermined clearance being disposed.

### CROSS-REFERENCE TO RELATED APPLICATION

This application claims priority under 35 USC 119 from Japanese Patent Applications No. 2005-087155 and No. 2005-237484, the disclosures of which are incorporated by reference herein.

### BACKGROUND OF THE INVENTION

1. Field of the Invention

The present invention relates to a method of manufacturing a liquid droplet discharge head that discharges liquid droplets and to a liquid droplet discharge head manufactured by this method.

2. Description of the Related Art

Conventionally, there have been known inkjet recording apparatus that selectively discharge ink droplets from plural nozzles of an inkjet recording head (sometimes referred to simply as a “recording head” below) that reciprocally moves in a main scanning direction, and which print characters and images on recording media such as recording paper conveyed in a sub-scanning direction.

The recording head is configured by nozzles that discharge ink droplets, chambers (pressure chambers) that are communicated with the nozzles and filled with ink, a diaphragm that configures part of the chambers, and a single-plate piezoelectric actuator (piezoelectric member) that pressurizes/depressurizes the pressure chambers via the diaphragm.

For example, Japanese Patent Application Publication (JP-A) No. 2003-48323 discloses a recording head manufacturing method where, as shown in FIG. 27, a piezoelectric element unit 206, in which plural piezoelectric elements 204 that have rectangular shapes are two-dimensionally arranged on a piezoelectric plate 202 that is separably adhered to an unillustrated substrate, is patterned, and then a diaphragm is adhered to the surface of the piezoelectric plate 202 opposite from the surface facing the substrate, and the substrate is separated from the piezoelectric elements 204.

Incidentally, when the piezoelectric elements 204 are disposed on the piezoelectric plate 202 that is made of lead zirconium titanate and has a thickness of 35 μm, there is a limit on the area of the piezoelectric plate 202, and when applied to a large recording apparatus capable of high-speed printing, it is necessary to dispose, in a staggered manner, heads 216 made with a maximum-area piezoelectric plate 202 and to ensure that they have a width that is slightly larger than the width of the recording medium, as shown in FIG. 26A.

However, in this case, because the plural heads 216 are required, housings 218 corresponding to the heads 216 also become necessary, and the number of parts increases. For this reason, the number of man-hours significantly increases, which results in a significant cost increase.

### SUMMARY OF THE INVENTION

In view of these circumstances, it is an object of the present invention to obtain a liquid droplet discharge head and a method of manufacturing the liquid droplet discharge head, in which the number of parts is small and which can inexpensively accommodate large apparatus.

In order to achieve this object, a first aspect of the invention provides a method of manufacturing a liquid droplet discharge head including nozzles that discharge liquid droplets, pressure chambers that are communicated with the nozzles and filled with liquid droplets, a diaphragm that configures part of the pressure chambers, and piezoelectric member groups that are configured by joining, to the surface of the diaphragm, piezoelectric plates that have groove portions and are processed in a matrix, the piezoelectric member groups including piezoelectric elements that cause the diaphragm to be displaced as a result of a voltage being applied to the piezoelectric elements, the method comprising: processing the piezoelectric plates in a matrix to prepare the piezoelectric member groups; and joining the piezoelectric member groups to the diaphragm in a state where mutual boundaries of the piezoelectric member groups are fitted together and with a predetermined clearance being disposed.

In this aspect, the pressure chambers filled with ink droplets are communicated with the nozzles that discharge the ink droplets, and the piezoelectric member groups where the piezoelectric plates have been individuated in a matrix are disposed on the surface of the diaphragm configuring part of the pressure chambers. The diaphragm is displaced when a voltage is applied to the piezoelectric member groups.

The piezoelectric member groups are arranged in a matrix in a state where their mutual boundaries are fitted together and are joined to the diaphragm with a predetermined clearance being disposed. Thus, the nozzles can be disposed in a high density and high resolution can be realized.

Also, because a predetermined clearance is disposed between the piezoelectric member groups, it is ensured that the piezoelectric elements configuring the piezoelectric member groups are not broken even with the piezoelectric member groups disposed in a state where their mutual boundaries are fitted together.

Moreover, an increase in the area of one head can be enabled by joining the piezoelectric element groups individuated by the plural piezoelectric plates to the diaphragm and connecting them. Thus, the limit on the head size is eliminated, the head can be freely designed, the number of parts is reduced, and the cost can be reduced.

In a second aspect of the invention, in the liquid droplet discharge head manufacturing method based on the first aspect, the piezoelectric member groups individuated by the plural piezoelectric plates are classified and joined to the diaphragm.

In this aspect, the piezoelectric member groups individuated by the plural piezoelectric plates are classified, and those with few variations in the piezoelectric plates are joined together. Thus, they can be distributed such that a boundary is not imparted (the variations become small) in the joint portions of the piezoelectric member groups, and with respect to in-head variations in the discharge characteristics of the liquid droplets discharged from the nozzles, the effect that it becomes difficult for poor gradation to occur in the image is obtained.

In a third aspect of the invention, the piezoelectric member groups of the second aspect are classified by the thicknesses of the piezoelectric plates.

In a fourth aspect of the invention, positioning marks for positioning the piezoelectric member groups with respect to a positioning reference formed on a flow path plate unit including the diaphragm based on any of the first to third aspects are patterned together with the piezoelectric member groups on fixing substrates that provisionally fix the piezoelectric member groups.

In this aspect, the positioning marks that position the piezoelectric member groups with respect to the positioning reference are patterned on the fixing substrates together with the piezoelectric member groups. Thus, because the relative positional relationships between the piezoelectric member groups and the positioning marks always match, the positioning precision of the piezoelectric member groups with respect to the flow path plate unit including the diaphragm is improved.

In a fifth aspect of the invention, when the piezoelectric member groups patterned on the plural fixing substrates based on the fourth aspect are to be respectively joined to the diaphragm, the positioning marks of the piezoelectric member groups to be joined from the second time on have similar shapes with respect to the positioning marks of the piezoelectric member group joined immediately before and are positioned with respect to the positioning marks.

When positioning is done using and mutually superposing marks with congruent shapes, usually they interfere with the positioning marks that have been previously joined, and joining from the second time on becomes impossible. However, according to this aspect, by giving the positioning marks substantially similar shapes, the inner shapes (or outer shapes) of the positioning marks are positioned with respect to the outer shapes (or inner shapes) of the positioning marks, and joining of multiple times from the second time on becomes possible without the positioning marks interfering.

In a sixth aspect of the invention, the method further comprises measuring the amount of positional displacement of the positioning marks that have been positioned with respect to the positioning reference based on the fourth or fifth aspect, and, after correcting the positional displacement amount, positioning, with respect to the positioning marks, the piezoelectric member group to be joined next.

In this aspect, the method further comprises measuring the amount of positional displacement of the positioning marks that have been positioned with respect to the positioning reference based on the fourth or fifth aspect, and, after correcting the positional displacement amount, positioning, with respect to the positioning marks, the piezoelectric member group to be joined next. Thus, the piezoelectric member groups become substantially positioned with respect to the positioning reference on the flow path plate unit including the diaphragm.

In a seventh aspect of the invention, a liquid droplet discharge head is manufactured by the liquid droplet discharge head manufacturing method based on any of the first to sixth aspects.

In this aspect, the liquid droplet discharge head is manufactured by the liquid droplet discharge head manufacturing method based on any of the first to sixth aspects. Thus, the effects based on any of the first to sixth aspects can be obtained.

In an eighth aspect of the invention, the heights of joint surfaces of adjacent piezoelectric member groups of the liquid droplet discharge head based on the seventh aspect are different.

In this aspect, the heights of the joint surfaces of adjacent piezoelectric member groups are changed. Thus, when a piezoelectric member group is to be joined next to a piezoelectric member group already joined to the diaphragm, it can be ensured that adhesive tape of a substrate disposing the piezoelectric member groups does not interfere with the piezoelectric member groups joined to the diaphragm.

Consequently, the clearance between the piezoelectric member groups can be narrowed, and the nozzles can be disposed in a high density. Also, the piezoelectric member groups can be made into smaller pieces, and handling becomes easy. Also, because the piezoelectric member groups can be made into smaller pieces, the sizes of the piezoelectric member groups can be further thinned, and improvements in quality and yield can be realized.

In a ninth aspect of the invention, the diaphragm of the eighth aspect is configured by an upper diaphragm and a lower diaphragm, through holes are formed in the upper diaphragm and in the lower diaphragm, the upper diaphragm and the lower diaphragm are disposed in a state where they are superposed such that the through holes are not communicated with each other, and the joint surfaces are the upper surface of the upper diaphragm and the upper surface of the lower diaphragm exposed through the through holes in the upper diaphragm.

In this aspect, the diaphragm is configured by an upper diaphragm and a lower diaphragm, and through holes are formed in the upper diaphragm and in the lower diaphragm. Also, the upper diaphragm and the lower diaphragm are disposed in a state where they are superposed such that the through holes are not communicated with each other, and the upper surface of the upper diaphragm and the upper surface of the lower diaphragm exposed through the through holes in the upper diaphragm serve as the joint surfaces of the piezoelectric member groups. Thus, the heights of the joint surfaces can be changed in the amount of the thickness of the diaphragm.

In a tenth aspect of the invention, a concave portion is formed in the upper surface of the diaphragm based on the eighth aspect, and the joint surfaces are the upper surface of the diaphragm and the bottom surface of the concave portion formed in the upper surface of the diaphragm.

In this aspect, a concave portion is formed in the upper surface of the diaphragm, and the upper surface of the diaphragm and the bottom surface of the concave portion formed in the upper surface of the diaphragm serve as the joint surfaces. Thus, the heights of the joint surfaces can be changed in the amount of the depth of the concave portion.

In an eleventh aspect of the invention, a concave portion is formed in the undersurface of the diaphragm corresponding to the upper surface of the diaphragm serving as the joint surface based on the tenth aspect.

In this aspect, a concave portion is formed in the undersurface of the diaphragm corresponding to the upper surface of the diaphragm serving as the joint surface. Thus, the thickness of the diaphragm can be made the same regardless of the heights of the joint surfaces to the diaphragm being different in adjacent piezoelectric member groups, and the deformation amount of the diaphragm can be made substantially the same.

In a twelfth aspect of the invention, in the liquid droplet discharge head based on any of the ninth to eleventh aspects, an auxiliary plate that makes the volumes of the pressure chambers that change due to the heights of the joint surfaces substantially the same is disposed inside the pressure chambers.

Usually, a concave portion is disposed in the undersurface of the diaphragm to change the heights of the joint surfaces and make the thickness of the diaphragm the same. However, the capacities of the pressure chambers become larger at the place where the concave portion is disposed in comparison to the place where the concave portion is not disposed.

In this aspect, the auxiliary plate is disposed, and the volumes of the pressure chambers that change due to the heights of the joint surfaces are made substantially the same.

### BRIEF DESCRIPTION OF THE DRAWINGS

FIG. 1 is a perspective view showing an inkjet recording apparatus to which an inkjet recording head pertaining to an embodiment of the invention has been applied;

FIG. 2 is a perspective view showing an inkjet recording unit to which the inkjet recording head pertaining to the embodiment of the invention has been applied;

FIG. 3A is a perspective view showing the configuration of the inkjet recording head pertaining to the embodiment of the invention, and FIG. 3B is a partially enlarged view of FIG. 3A;

FIG. 4A is an enlarged view showing a piezoelectric element of the inkjet recording head pertaining to the embodiment of the invention, and FIG. 4B is a cross-sectional view along line A-A of FIG. 4A;

FIG. 5 is a plan view showing the piezoelectric elements of the inkjet recording head pertaining to the embodiment of the invention;

FIGS. 6A to 6F are step diagrams schematically showing steps in the manufacture of the inkjet recording head pertaining to the embodiment of the invention;

FIG. 7 is a step diagram schematically showing the step of sandblasting a piezoelectric plate of the inkjet recording head pertaining to the embodiment of the invention;

FIGS. 8A to 8C are explanatory diagrams showing a method of manufacturing the inkjet recording head pertaining to the embodiment of the invention;

FIG. 9 is a partially enlarged view of FIG. 8C;

FIG. 10 is a perspective view showing the method of manufacturing the inkjet recording head pertaining to the embodiment of the invention;

FIG. 11 is a plan view showing a piezoelectric body in the method of manufacturing the inkjet recording head pertaining to the embodiment of the invention;

FIG. 12 is a plan view showing a positioning mark used in the manufacture of the inkjet recording head pertaining to the embodiment of the invention;

FIGS. 13A to 13C are plan views showing other examples of positioning marks used in the manufacture of the inkjet recording head pertaining to the embodiment of the invention;

FIGS. 14A and 14B are explanatory diagrams describing the action of FIGS. 13A to 13C;

FIG. 15A shows a method of joining together two piezoelectric plates, and FIG. 15B is an explanatory diagram showing a method of dividing and joining together piezoelectric plates;

FIG. 16 is a plan view showing the piezoelectric body of the inkjet recording head pertaining to the embodiment of the invention;

FIG. 17A shows discharge characteristics of ink droplets corresponding to FIG. 15A, and FIG. 17B is a graph showing discharge characteristics of ink droplets corresponding to FIG. 15B;

FIG. 18 is a cross-sectional view describing a problem when piezoelectric elements of an inkjet recording head are joined to a diaphragm;

FIG. 19 is a cross-sectional view showing a modification of a flow path plate unit of the inkjet recording head pertaining to the embodiment of the invention;

FIG. 20 is a cross-sectional view showing a state where piezoelectric elements are joined to the flow path plate unit of FIG. 19;

FIG. 21 is a partially exploded cross-sectional view of the flow path plate unit of FIG. 19;

FIGS. 22A and 22B are cross-sectional views when piezoelectric member groups of the inkjet recording head pertaining to the embodiment of the invention are joined to the diaphragm;

FIG. 23 is a cross-sectional view showing another modification of the flow path plate unit of the inkjet recording head pertaining to the embodiment of the invention;

FIG. 24 is a cross-sectional view showing yet another modification of the flow path plate unit of the inkjet recording head pertaining to the embodiment of the invention;

FIG. 25 is a cross-sectional view showing a state where an auxiliary pressure chamber plate is disposed on the flow path plate unit of the inkjet recording head pertaining to the embodiment of the invention;

FIG. 26A is a plan view showing a conventional inkjet recording head, and FIG. 26B is a plan view showing the inkjet recording head pertaining to the embodiment of the invention; and

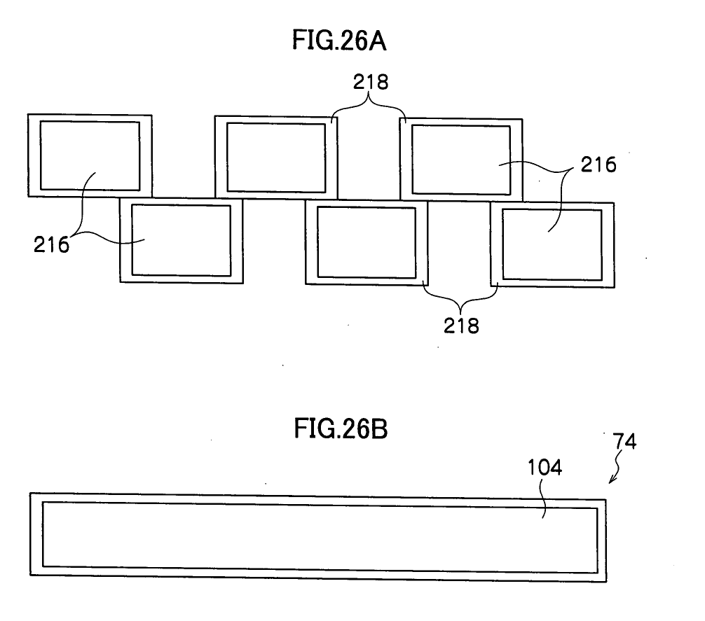

FIG. 27 is a plan view showing a conventional inkjet recording head.

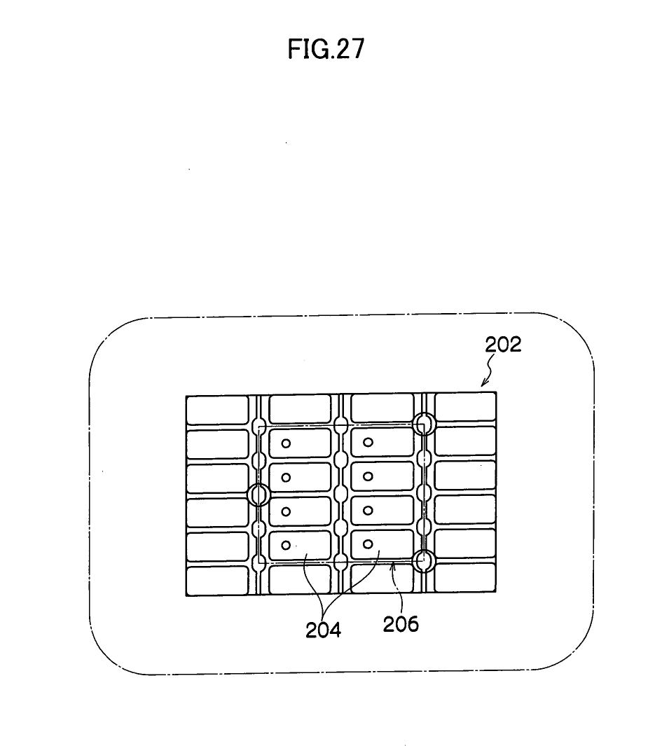

### DETAILED DESCRIPTION OF THE INVENTION

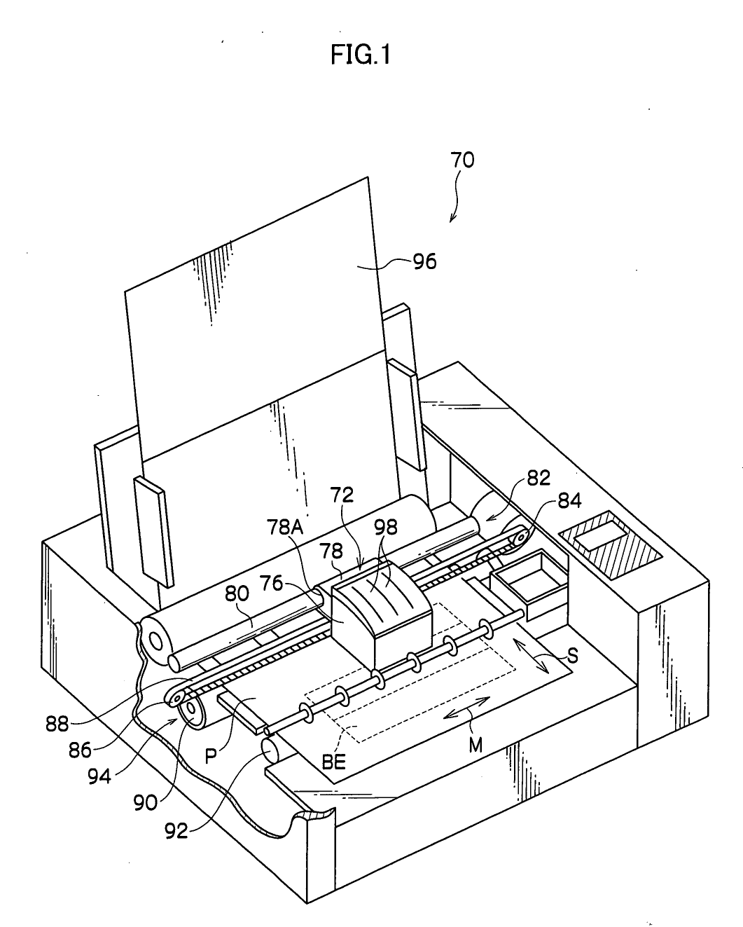

An inkjet recording head pertaining to an embodiment of the invention will be described below. First, an inkjet recording apparatus 70 shown in FIG. 1 will be described.

The inkjet recording apparatus 70 uses recording paper P as a recording medium. The direction in which the recording paper P is conveyed in the inkjet recording apparatus 70 is a sub-scanning direction and will be represented by arrow S, and the direction orthogonal to the conveyance direction is a main scanning direction and will be represented by arrow M.

The inkjet recording apparatus 70 includes a carriage 76 in which is loaded an inkjet recording unit 72 of the respective colors of black, yellow, magenta and cyan. A pair of brackets 78 is disposed in the carriage 76 such that the brackets 78 protrude upstream in the conveyance direction of the recording paper P, and a circular opening 78A is disposed in the brackets 78. A shaft 80 that is disposed along the main scanning direction is inserted into the opening 78A.

A drive pulley 84 and a driven pulley 86 that configure a main scanning mechanism 82 are disposed at both ends in the main scanning direction. A timing belt 88 is wound around the drive pulley 84 and the driven pulley 86, and the carriage 76 is fixed to part of the timing belt 88 such that the carriage 76 is reciprocally movable in the main scanning direction.

The inkjet recording apparatus 70 also includes a sub-scanning mechanism 94 that comprises a conveyance roller 90 and a discharge roller 92. A stack of sheets of the recording paper P before image printing is placed in a paper supply tray 96, and the sub-scanning mechanism 94 conveys the recording P, which is supplied one sheet at a time from the paper supply tray 96, at a predetermined pitch in the sub-scanning direction.

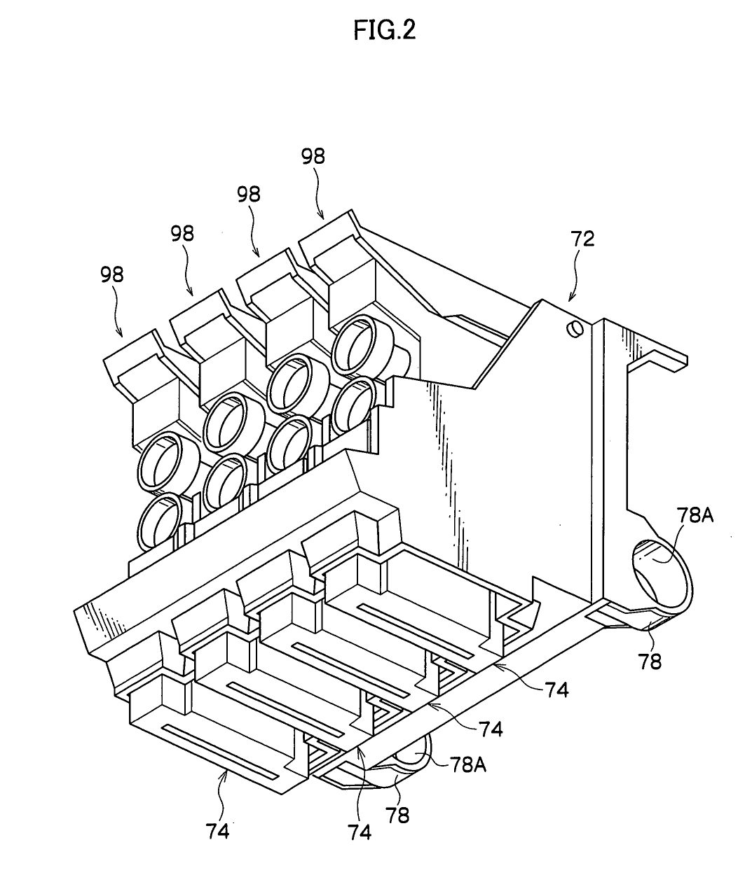

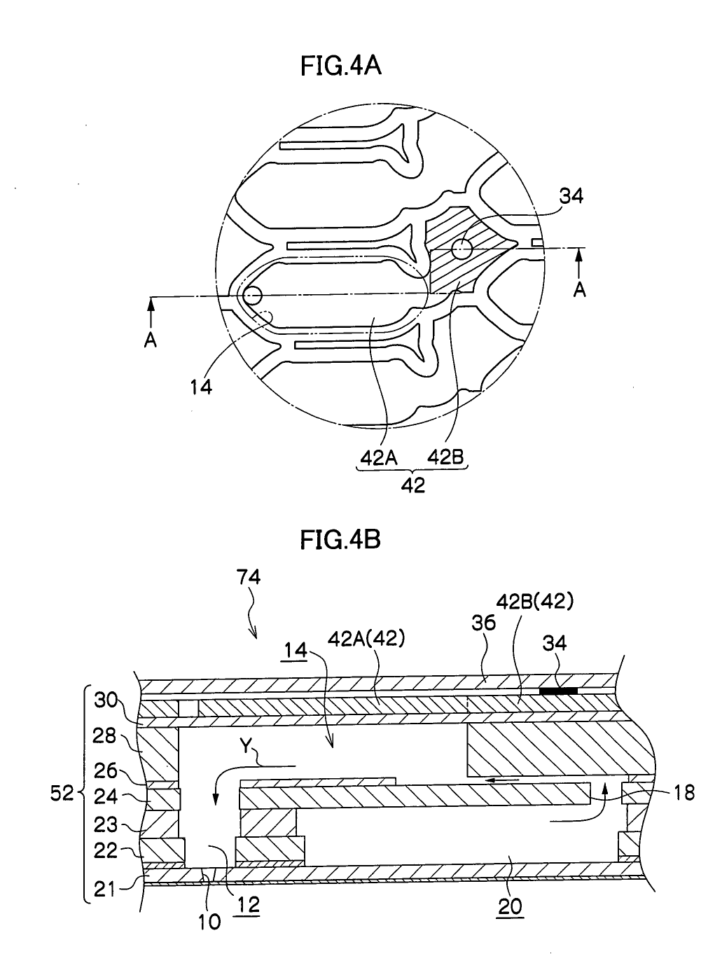

As shown in FIG. 2, the inkjet recording unit 72 of the respective colors is one where inkjet recording heads 74 and ink tanks 98 that supply the inks to the inkjet recording heads 74 are integrally configured. The inkjet recording unit 72 is loaded in the carriage 76 such that plural nozzles 10 (see FIG. 4B) formed in the undersurfaces of the inkjet recording heads 74 face the recording paper P.

Consequently, part of an image based on image data is recorded in a predetermined band region BE as a result of ink droplets being selectively discharged from the nozzles 10 onto the recording paper P while the inkjet recording heads 74 are moved by the main scanning mechanism 82 (see FIG. 1) in the main scanning direction.

Then, when one movement in the main scanning direction ends, the recording paper P is conveyed at a predetermined pitch in the sub-scanning direction by the sub-scanning mechanism 94 (see FIG. 1), and part of the image based on image data is recorded in the next band region while the inkjet recording heads 74 are again moved in the main scanning direction (opposite direction from the aforementioned direction). This operation is repeated several times, whereby an entire image based on image data is recorded in full color on the recording paper P.

Next, the configuration of the inkjet recording head pertaining to the embodiment of the invention will be described.

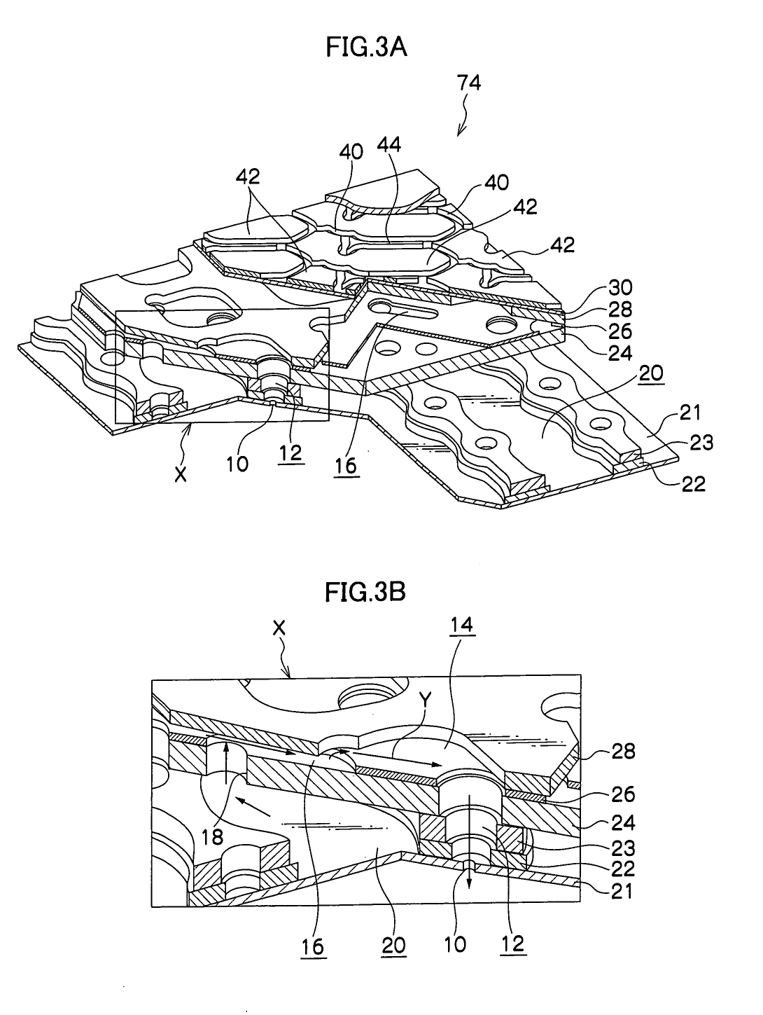

As shown in FIG. 3A and FIG. 3B, the inkjet recording head 74 includes a common ink chamber 20 to which ink is supplied from the ink tank 98 (see FIG. 2). An open portion 18 is disposed in the common ink chamber 20, a pressure chamber 14 is communicated with the common ink tank 20 via an ink supply path 16, and the ink inside the common ink chamber 20 is supplied.

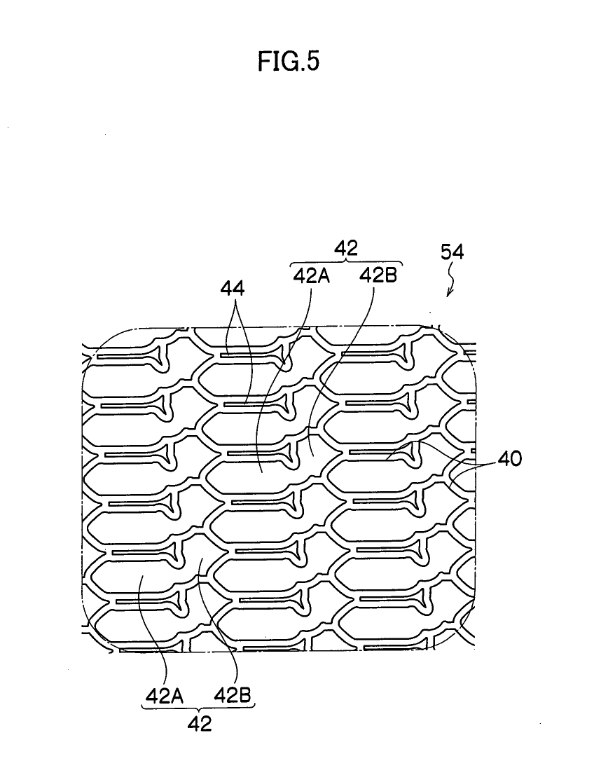

The plural nozzles 10 disposed in a matrix are disposed in the inkjet recording head 74 and communicated with the pressure chambers 14 via nozzle communication chambers 12. A diaphragm 30 that is elastic in the vertical direction is disposed on the upper surfaces of the pressure chambers 14, and as shown in FIG. 5, piezoelectric elements 42 are disposed in a matrix on the upper surface of the diaphragm 30 corresponding to the pressure chambers 14.

The piezoelectric elements 44 all have substantially the same shape. As shown in FIG. 4A, each of the piezoelectric elements 44 is configured by an elliptical portion 42A and a polygonal portion 42B (hatching region). The elliptical portion 42A has a substantially elliptical shape, is slightly smaller than the pressure chamber 14, which is substantially hexagonal, and is positioned above the pressure chamber 14. The polygonal portion 42B is connected to the elliptical portion 42A, bends in the same planar shape of the elliptical portion 42A from an end portion of the elliptical portion 42A, and has a pentagonal shape that is slightly smaller than the elliptical portion 42A. The piezoelectric elements 42 are disposed in a matrix in a state where their mutual boundaries are fitted together.

As shown in FIG. 5, dummy portions 44 are disposed on the same plane as the piezoelectric elements 42 between mutually adjacent elliptical portions 42A in a column direction, and groove portions 40 are disposed between mutually adjacent piezoelectric elements 42 and between the piezoelectric elements 42 and the dummy portions 44.

As shown in FIG. 4A and FIG. 4B, each of the polygonal portions 42B serves as an electric pad portion that conducts electrical connection. An electric substrate 36 is joined to the polygonal portion 42B via ball solder 34. When a voltage is applied to the polygonal portion 42B, the elliptical portion 42A positioned above the pressure chamber 14 is deformed by electrostriction and becomes a drive portion that pressurizes the ink inside the pressure chamber 14. When the ink inside the pressure chamber 14 is pressurized in this manner, ink droplets are discharged from the nozzle 10.

Here, because the piezoelectric elements 42 disposed in a matrix on the upper surface of the diaphragm 30 have substantially the same shape, the displacement amount of the diaphragm 30 that is displaced by the piezoelectric elements 42 can be made the same in each nozzle 10, and the discharge characteristics of the ink droplets can be made uniform.

Also, because the shapes of the dummy portions 44 are made substantially the same, the condition of support by which the piezoelectric elements 42 are supported can be made substantially the same in each nozzle 10, and the discharge characteristics of the ink droplets can be made more uniform.

Moreover, because the groove portions 40 are disposed between the dummy portions 44 and the piezoelectric elements 42, the dummy portions 44 are completely independent from the piezoelectric elements 42 and are not at all affected by the application of the voltage to the piezoelectric elements 42.

Next, the method of manufacturing the inkjet recording head pertaining to the embodiment of the invention will be described.

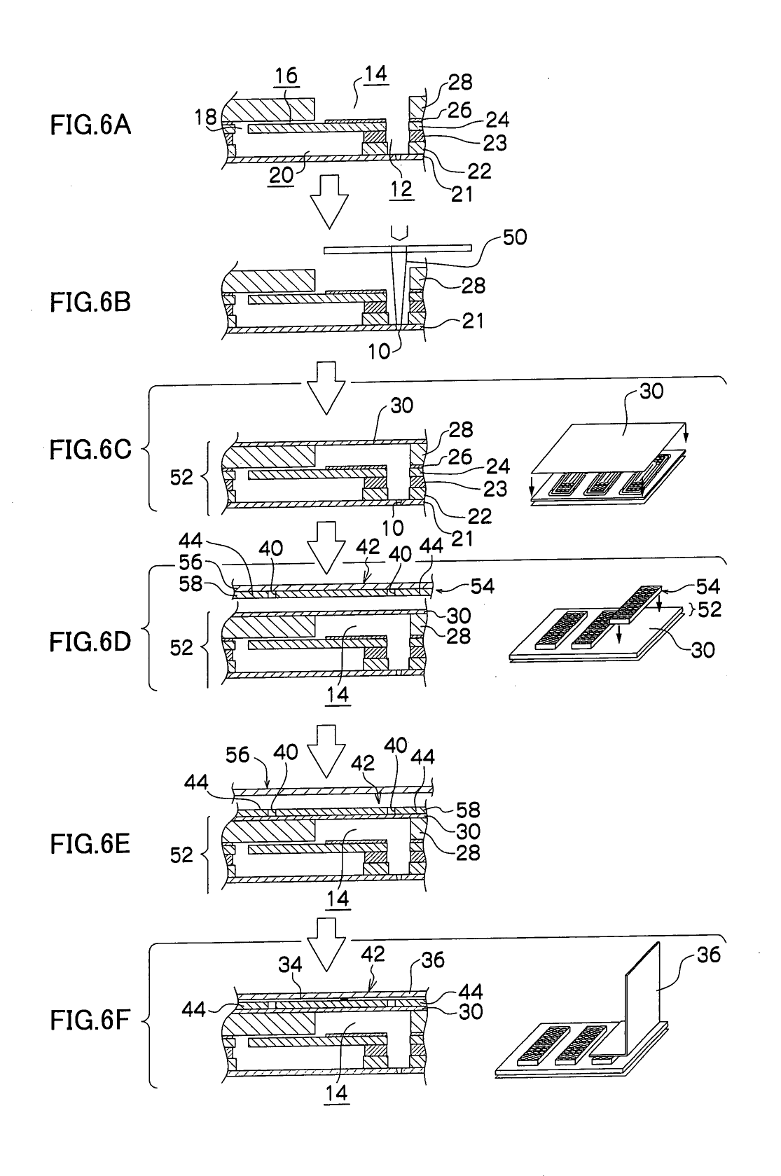

As shown in FIG. 6A, the inkjet recording head 74 is formed by laminating and joining together in order a nozzle plate 21 in which the nozzle 10 is formed (see FIG. 6B), an ink pool plate 22 and an ink pool plate 23 that form the nozzle communication chamber 12 and the common ink chamber 20, a through plate 24 that forms the open portion 18 of the common ink chamber 20 and the nozzle communication chamber 12, an ink supply path plate 26 in which the ink supply path 16 is formed, and a pressure chamber plate 28 in which the pressure chamber 14 is formed.

The surface of the nozzle plate 21 is coated with a water-repellant coating film, the nozzle 10 is formed by an excimer laser 50 as shown in FIG. 6B, and the diaphragm 30 is adhered to the pressure chamber plate 28 after the formation of the nozzle as shown in FIG. 6C.

The material of the nozzle plate 21 is polyimide, and the material of the ink pool plate 22, the ink pool plate 23, the through plate 24, the ink supply path plate 26, the pressure chamber plate 28 and the diaphragm 30 is SUS.

That which comprises the nozzle plate 21, the ink pool plate 22, the ink pool plate 23, the through plate 24, the ink supply path plate 26, the pressure chamber plate 28 and the diaphragm 30 adhered together is called a flow path plate unit 52.

Here, as shown in FIG. 6D, a piezoelectric unit 54 (called “the PA substrate 54” below) is created which includes the piezoelectric elements 42 to which the voltage is applied and the dummy portions 44 to which the voltage is not applied.

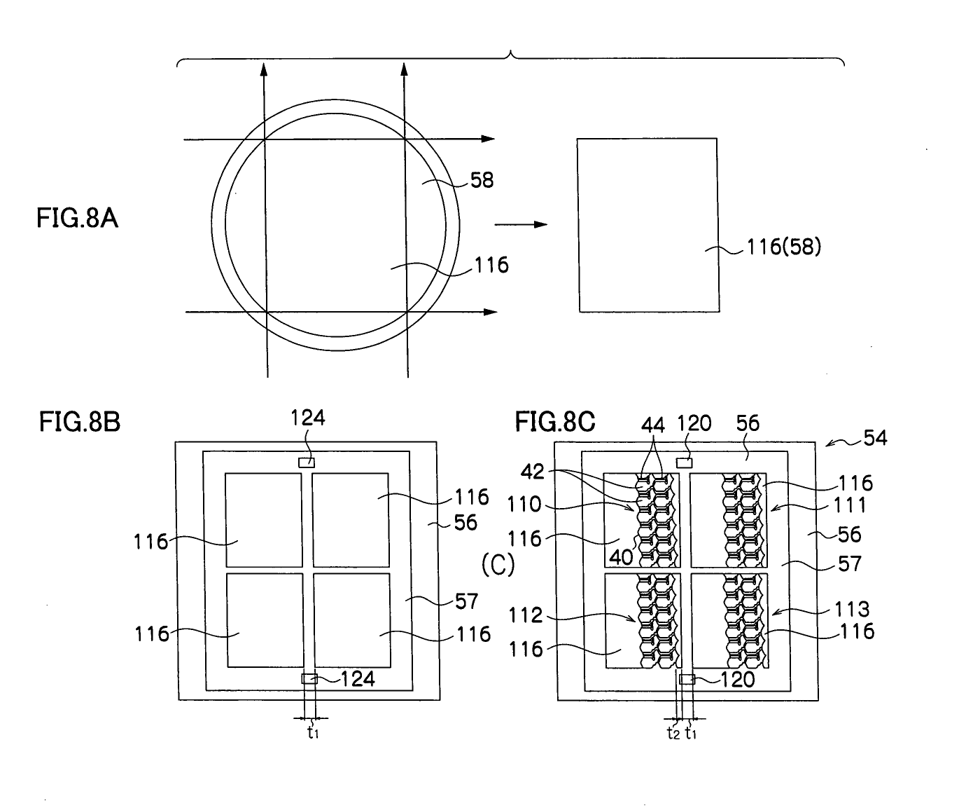

First, as shown in FIG. 8A, lapping is administered to a piezoelectric material block (not shown) to create a piezoelectric plate 58. The thickness of the piezoelectric plate 58 is determined on the basis of the amount of flexural deformation and the drive voltage necessary for the piezoelectric elements 42. In the present embodiment, this is about φ 15 mm and the thickness is about 40±6 μm.

Next, the piezoelectric plate 58 is diced into rectangles. Here, one rectangular chip 116 is formed from one piezoelectric plate 58, but the area of one rectangular chip 116 may be reduced to form plural rectangular chips 116.

Then, as shown in FIG. 8B, the diced rectangular chips 116 are provisionally adhered to a fixing substrate 56 via a separable adhesive such as a heat-foaming adhesive film 57 (having the property that it foams when heated at a predetermined temperature after adhesion such that its adhesive force significantly drops).

Here, marks 124, whose references are marks 122 formed on the flow path plate unit 52 including the diaphragm 30, are formed in advance on the fixing substrate 56 in order to align the position at which the fixing substrate 56 is joined to the flow path plate unit 52 (see FIG. 6D).

After the rectangular chips 116 have been adhered and fixed to the fixing substrate 56, later-described sandblasting is used to form (so-called individuation) the groove portions 40 with a constant width in the rectangular chips 116, whereby the PA substrate 54, in which the piezoelectric elements 42, the dummy portions 44 and the groove portions 40 are formed, is created, as shown in FIG. 5 and FIG. 8C.

Here, the sandblasting will be described below.

If the rectangular chips 116 are disposed such that the clearance between adjacent rectangular chips 116 is eliminated when the rectangular chips 116 are provisionally adhered to the fixing substrate 56 as shown in FIG. 8B, the end surfaces of the rectangular chips 116 contact each other, and sometimes the rectangular chips 116 break due to this shock. For this reason, the rectangular chips 116 are provisionally adhered to the fixing substrate 56 in a state where a clearance t₁ for rectangular chip arrangement is disposed between the rectangular chips 116.

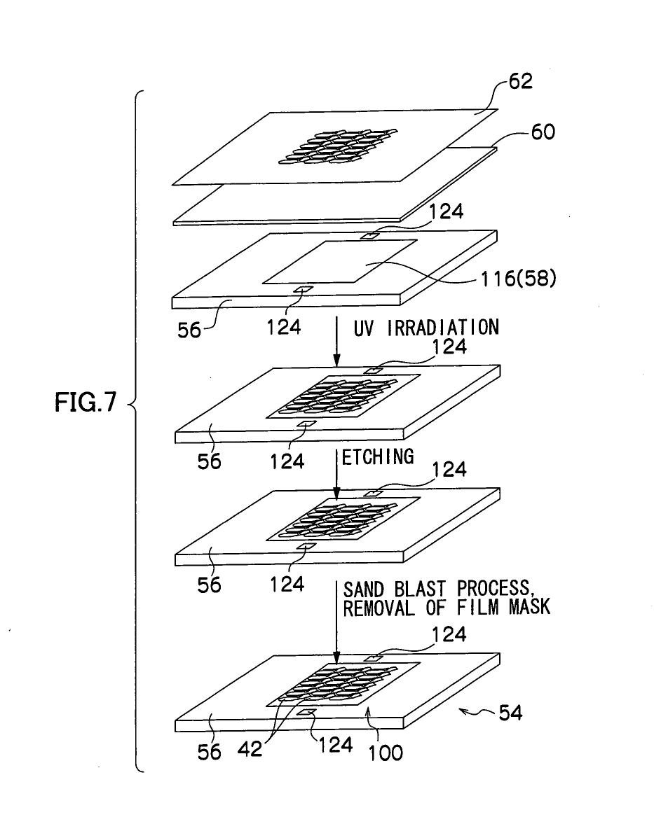

Then, as shown in FIG. 7 (in FIG. 8C, four rectangular chips 116 are shown for convenience of explanation, but in FIG. 7 one rectangular chip 116 is shown in order to facilitate understanding), a photosensitive film resist 60 is adhered onto the provisionally adhered rectangular chip 116. In the present embodiment, a urethane film resist having a thickness of 50 μm is used. Thereafter, an exposure mask 62, which includes a pattern through which ultraviolet (UV) light is transmitted just to the piezoelectric elements 42 and the dummy portions 44, is separately created and adhered to the film resist 60.

The exposure mask 62 is patterned using the marks 124 on the fixing substrate 56 as a reference. The rectangular chip 116 covered by the film resist 60 is irradiated with ultraviolet light via the exposure mask 62 and thereafter etched. An etching liquid such as sodium carbonate having the characteristic that it does not remove the portion irradiated with ultraviolet light but can reliably remove the other portions is used for the etching liquid.

Due to the aforementioned process, just the piezoelectric elements 42 and the dummy portions 44 shown in FIG. 5 are covered with the film resist 60, and the film resist 60 is removed from the other portions. In other words, the portions that are removed become the groove portions 40 with a constant width.

Next, sandblasting is conducted. Sandblasting is conducted under the condition that the portions of the rectangular chip 116 from which the film resist 60 has been removed and which are exposed (i.e., the groove portions 40) are reliably grinded and removed, and the portions where the film resist 60 remains (i.e., the piezoelectric elements 42 and the dummy portions 44) are not grinded.

Usually, in sandblasting, blast powder collides with the side surfaces of the piezoelectric plate 58. Thus, processing in the width direction of the rectangular chip 116 (horizontal processing) advances in parallel with the advancement of processing with respect to the thickness direction of the rectangular chip 116 (vertical processing). The processing speed of the horizontal processing is dependent on the width of the groove portions 40 formed in the rectangular chip 116. In other words, the processing speed of the horizontal processing becomes greater because as the width of the groove portions 40 becomes larger, the blast powder more easily collides with the side surfaces of the rectangular chip 116.

However, in the present embodiment, the horizontal processing amount becomes the same because the groove portions 40 have a constant width. For this reason, the piezoelectric elements 42 can be made to have a uniform dimension, and high-precision processing becomes possible. Additionally, the film resist 60 remaining on the surface of the piezoelectric plate 58 is removed and washing is administered after the sandblasting.

According to the sandblasting in this manner, processing can be precisely conducted easily and in a short amount of time even with respect to the piezoelectric elements 42 and the dummy portions 44 of the present embodiment, which have complex shapes. Also, for this reason, the cost can be reduced.

Additionally, due to this sandblasting, the surface on which are formed the piezoelectric elements 42 and the dummy portions 44 arranged in a matrix is adhered to the diaphragm 30 of the flow path plate unit 52 (called “PA joining” below; the details will be described later), as shown in FIG. 6D.

Here, because the dummy portions 44 are disposed around the piezoelectric elements 42, stress when the PA substrate 54 is joined to the diaphragm 30 is also dispersed to the dummy portions 40, and concentration of stress in the piezoelectric elements 42 is avoided.

For this reason, the occurrence of factors causing deterioration of the discharge characteristics of the ink droplets, such as cracks and fissures in the elliptical portions 42A resulting from stress concentrating in the piezoelectric elements 42, can be prevented. Also, because the groove portions 40 are disposed around the piezoelectric elements 42, the difference in the coefficient of linear expansion between the PA substrate 54 and the diaphragm 30 can be absorbed at the time of PA joining.

Also, although they are not illustrated, formed in advance by sputtering as electrode layers on both sides of the piezoelectric plate 58 are a first electrode layer (bottom side) and a second electrode layer (top side). By adhering, with an adhesive, the piezoelectric plate 58 to the diaphragm 30, which doubles as a common electrode, the piezoelectric elements 42 and the diaphragm 30 are also electrically connected via the first electrode layer. In the present embodiment, chrome, nickel, and gold are used as the electrode layer materials.

Then, as shown in FIG. 6E, the fixing substrate 56 is heated to reduce the adhesive force of the heat-foaming adhesive film and remove the fixing substrate 56.

Incidentally, as shown in FIG. 8C, when the plural piezoelectric elements 42, the dummy portions 44 and the groove portions 40 (see FIG. 5) are patterned on the rectangular chips 116, the piezoelectric elements 42 end up being segmented at the end portions of the rectangular chips 116 because the shapes of the piezoelectric elements 42 are linear. For this reason, regions that are not to be patterned arise in advance at the end portions of the rectangular chips 116 (pattern clearance t₂).

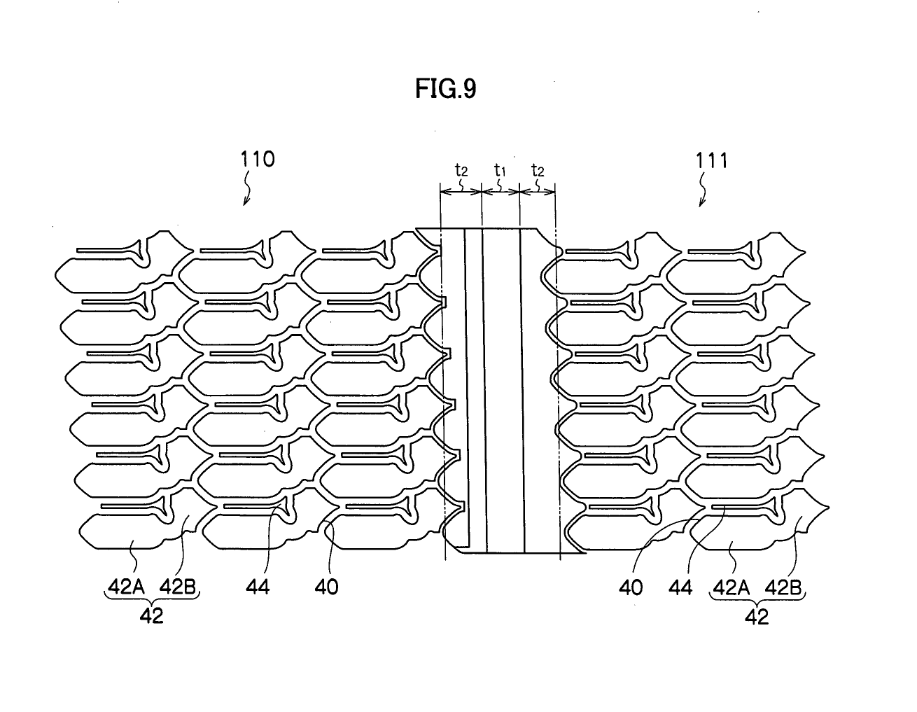

Consequently, as shown in FIG. 9, a useless region comprising the sum of the clearance t₂ (of the rectangular chip 116 on the left side), the clearance t₁ and the clearance t₂ (of the rectangular chip 116 on the right side) arises between the piezoelectric member group 110 and the piezoelectric member group 111 formed by the rectangular chips 116, and the nozzles 10 cannot be disposed in this region.

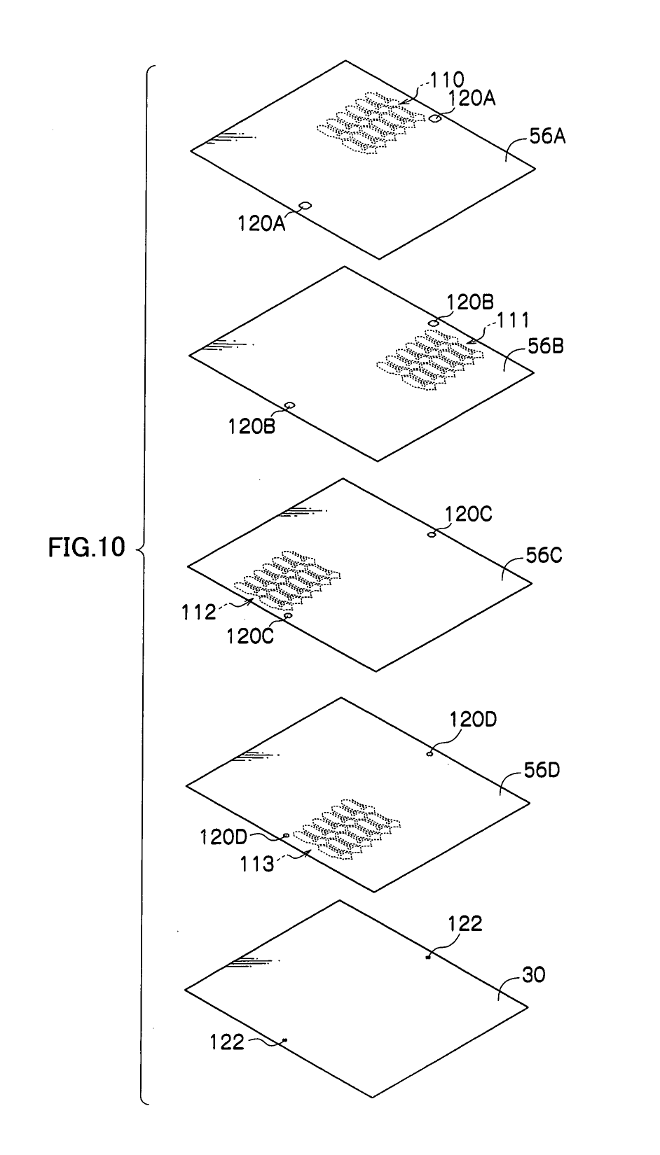

For this reason, in the present invention, in the PA joining, as shown in FIG. 10, the piezoelectric member groups 110, 111, 112 and 113 on the fixing substrate 56 are separated into groups, each group is respectively separately adhered to fixing substrates 56A, 56B, 56C and 56D, and thereafter the piezoelectric member groups 110, 111, 112 and 113 on the fixing substrates 56A, 56B, 56C and 56D are joined in order to the diaphragm 30.

In the description here, the four piezoelectric member groups 110, 111, 112 and 113 are used, but any number of groups is alright as long as there are plural piezoelectric member groups. Moreover, in the description here, one piezoelectric member group is adhered to one fixing substrate, but plural piezoelectric member groups may also be provisionally adhered to one fixing substrate.

Alignment marks 120 (120A, 120B, 120C and 120D) with respect to the marks 124 formed on the fixing substrate 56 are formed on the fixing substrates 56A, 56B, 56C and 56D.

The marks 120A, 120B, 120C and 120D are respectively formed as positioning references with respect to the flow path plate unit 52 including the diaphragm 30 when the piezoelectric member groups 110, 111, 112 and 113 are to be joined to the diaphragm 30. Thus, the piezoelectric member groups 110, 111, 112 and 113 are aligned at predetermined positions on the diaphragm 30.

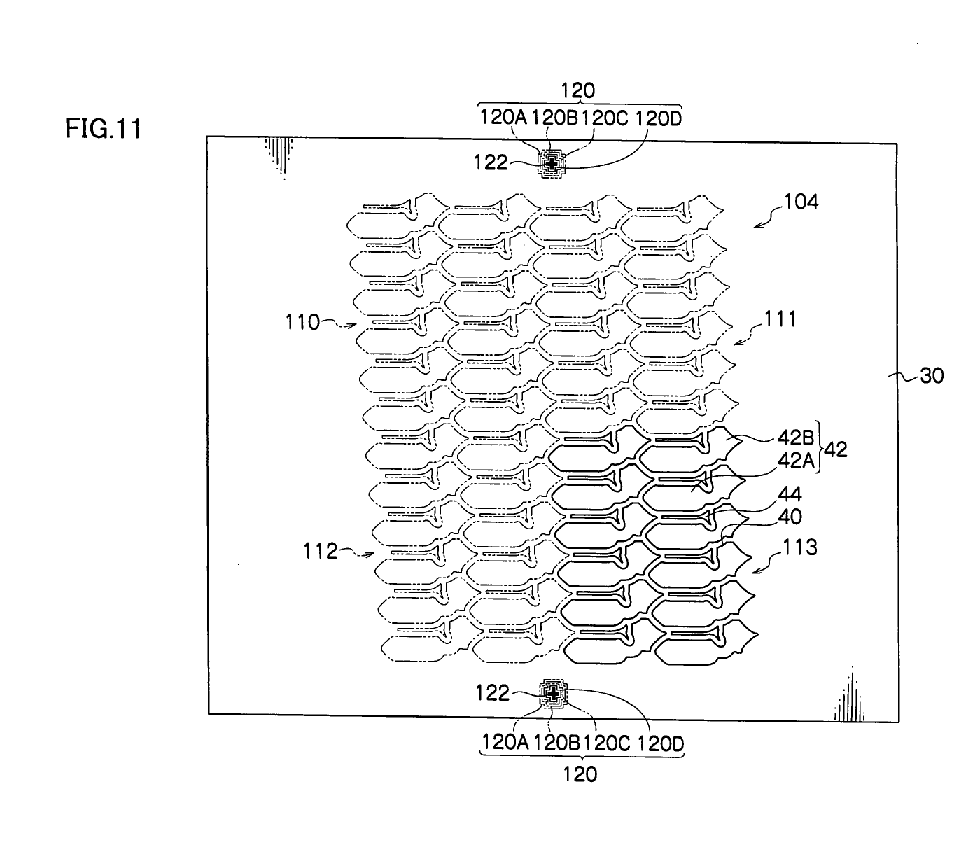

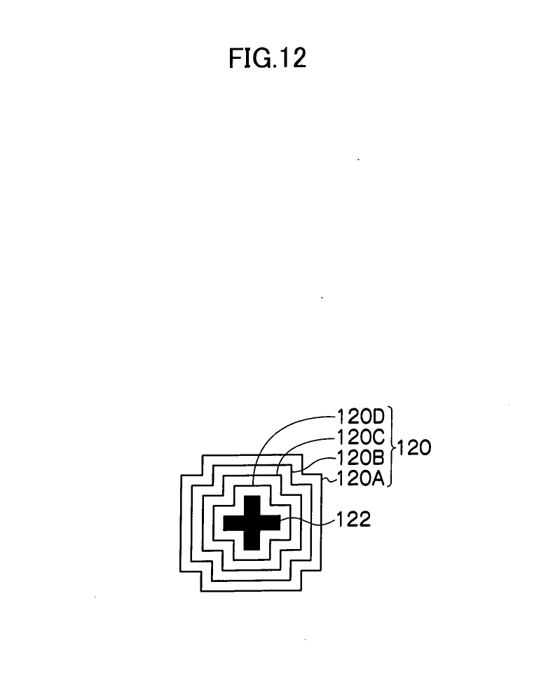

Here, as shown in FIG. 11 and FIG. 12, the marks 120 configured by the marks 120A, 120B, 120C and 120D are formed together when the plural piezoelectric elements 42, the dummy portions 44 and the groove portions 40 are patterned on the rectangular chips 116 as shown in FIG. 8C, and the marks 120A, 120B, 120C and 120D are also respectively provisionally adhered to the fixing substrates 56A, 56B, 56C and 56D when the piezoelectric member groups 110, 111, 112 and 113 on the fixing substrate 56 are respectively provisionally adhered to the fixing substrates 56A, 56B, 56C and 56D.

As shown in FIG. 10 and FIG. 12, the marks 120 formed on the flow path plate unit 52 including the diaphragm 30 have a cross-like shape. In the order in which the piezoelectric member groups are joined, the mark 120D is formed on the fixing substrate 56D and has an outline cross-like shape slightly larger than the outer edge of the mark 122. The mark 120C is formed on the fixing substrate 56C and has a substantially similar shape that is slightly larger than the mark 120D.

The mark 120B is formed on the fixing substrate 56B and has a substantially similar shape that is slightly larger than the mark 120C. The mark 120A is formed on the fixing substrate 56A and has a substantially similar shape that is slightly larger than the mark 120B. When the piezoelectric member groups 110, 111, 112 and 113 are joined, each group is aligned with respect to the mark joined immediately before.

In other words, the fixing substrate 56D is aligned with respect to the mark 122 on the flow path plate unit 52 including the diaphragm 30, the fixing substrate 56C is aligned with respect to the mark 120D on the fixing substrate 56D, the fixing substrate 56B is aligned with respect to the mark 120C on the fixing substrate 56C, and the fixing substrate 56A is aligned with respect to the mark 120B on the fixing substrate 56B.

When a piezoelectric member group is aligned with respect to the marks of the piezoelectric member group joined immediately before, positional displacement ends up becoming cumulative. Because the positions of the piezoelectric elements 42 with respect to the pressure chambers 14 are important, the amount of positional displacement between the marks 122 on the flow path plate unit 52 and the marks 120D is measured with a microscope. Then, on the basis of the measurement result, correction is made in the direction in which the positional displacement amount is cancelled.

Here, one each of the marks 120A, 120B, 120C and 120D was respectively formed on the fixing substrates 56A, 56B, 56C and 56D, but the invention is not limited to this because it suffices as long as the fixing substrates 56A, 56B, 56C and 56D can be precisely positioned with respect to the flow path plate unit 52 including the diaphragm 30.

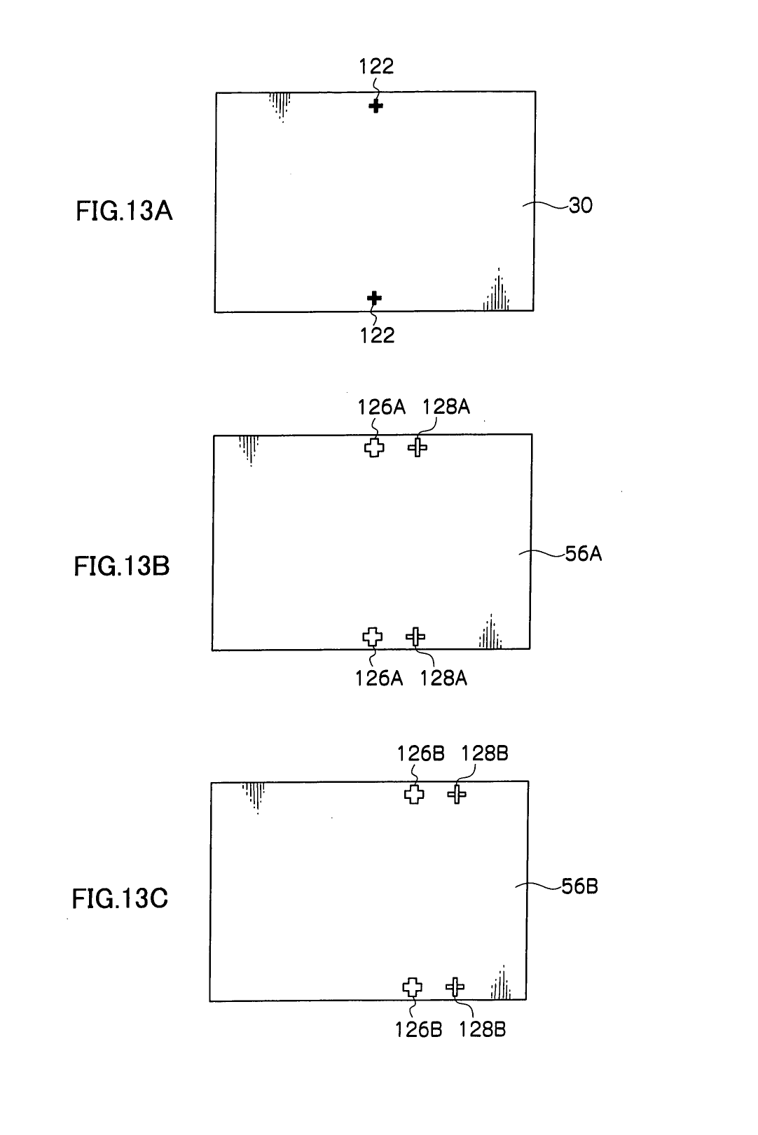

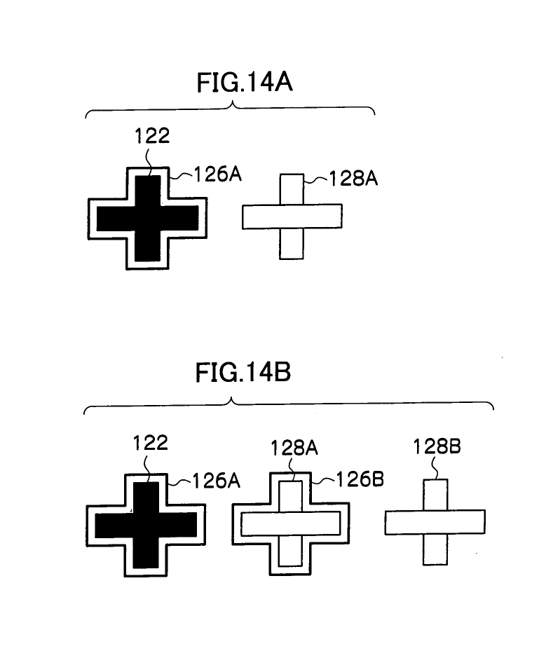

For example, as shown in FIGS. 13B and 13C, two each of marks 126A and 128A and marks 126B and 128B may also be formed on the fixing substrates 56A and 56B. In this case, as shown in FIG. 14A, the marks 126A are marks aligned with respect to the marks 122 on the flow path plate unit 52 (see FIG. 13A), and as shown in FIG. 14B and FIG. 14C, the marks 128A are marks serving as references with respect to the marks 126B of the piezoelectric member group to be joined next.

Also, here, the marks 126A, 128A, 126B and 128B have substantially cross-like shapes, but the invention is not limited to this because it suffices as long as the marks become reference points for alignment. As long as the marks have substantially similar shapes, they may also be circular or triangular.

Incidentally, there are variations in the thickness of the piezoelectric plate 58. Thus, when plural piezoelectric plates 58 are used, the piezoelectric member groups 110, 111, 112 and 113 are classified by the thicknesses of the piezoelectric plates 58, and they are joined together such that the ones with few variations in the piezoelectric plates 58 become adjacent. The thicknesses of the piezoelectric plates 58 may be measured directly, and there is also a method where piezoelectric chips (not shown) are processed to have the same area, the weight of the piezoelectric chips is measured, and the thicknesses are converted from the specific gravity of the piezoelectric chips.

Then, in a piezoelectric body 104 formed as a result of the plural piezoelectric member groups 110, 111, 112 and 113 being joined together, the polygonal portions 42B of the piezoelectric elements 42 become electric pad portions for electrical connection, and as shown in FIG. 6F, ball solder 34 is formed on each piezoelectric element 42 and the electric substrate 36 is joined via the ball solder 34.

Because the second electrode layer is formed on the upper surface of the piezoelectric plate 58, the piezoelectric elements 42 and the electric substrate 36 are electrically connected via the second electrode layer. Also, the electric substrate 36 and the diaphragm 30 are connected via unillustrated contacts.

Finally, the inkjet recording head 74 of the present embodiment is completed as a result of attaching unillustrated ink supply members and the like.

The inks are introduced from the ink tanks 98 (see FIG. 2) to the inkjet recording heads 74 completed in this manner, and as shown in FIGS. 3B and 4B, the ink flows along arrow Y to fill the common ink tank 20, the ink supply path 16, the pressure chamber 14 and the nozzle communication chamber 12.

Next, the action of the inkjet recording head 74 pertaining to the present embodiment will be described.

As shown in FIG. 5, the piezoelectric elements 42 configuring the piezoelectric member groups 110, 111, 112 and 113 are disposed in a matrix in a state where their mutual boundaries are fitted together, and the dummy portions 44 are disposed on the same plane as the piezoelectric elements 42 between the elliptical portions 42A of adjacent piezoelectric elements 42 in the column direction. Because the piezoelectric elements 42 are disposed in a matrix in a state where their mutual boundaries are fitted together in this manner, the nozzles 10 can be arranged in a high density and high resolution can be realized.

Also, in the present invention, as shown in FIG. 10, the piezoelectric member groups 110, 111, 112 and 113 on the fixing substrate 56 are divided into groups, respectively adhered to the fixing substrates 56A, 56B, 56C and 56D by group, and thereafter joined in order to the diaphragm 30.

Thus, at least the clearance t₁ for rectangular chip arrangement becomes unnecessary, and the clearance between adjacent piezoelectric member groups (e.g., the piezoelectric member group 110 and the piezoelectric member group 111) can be reduced.

Also, the groove portions 40 are disposed between adjacent piezoelectric elements 42 and between the piezoelectric elements 42 and the dummy portions 40, and the piezoelectric member groups 110, 111, 112 and 113 are joined together along the shapes of the groove portions 40. Thus, as shown in FIG. 11, the clearance between the piezoelectric member groups can be reduced even with respect to the piezoelectric elements 42, which are disposed in a state where their mutual boundaries are fitted together.

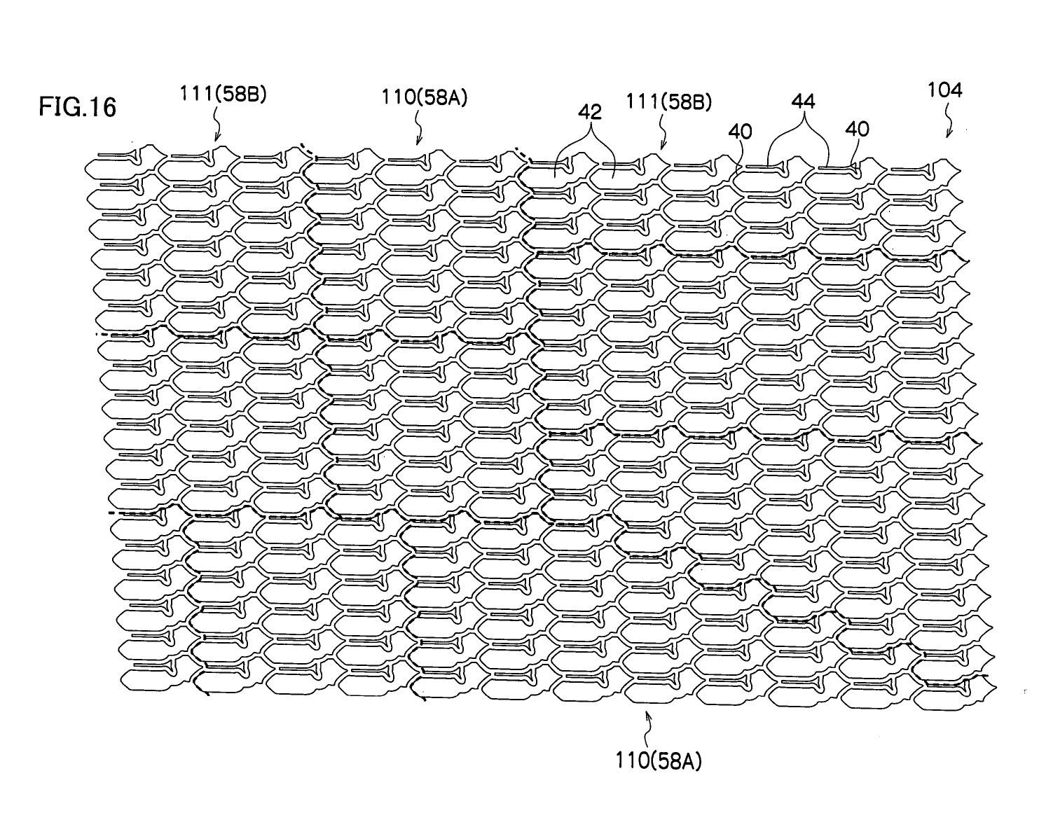

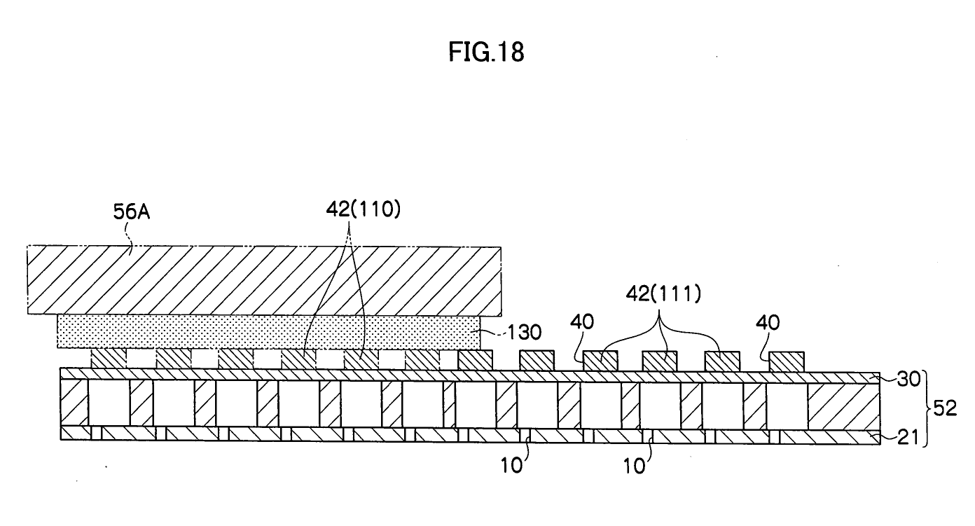

Thus, as shown in FIG. 16 and FIG. 18B, an increase in the area of one inkjet recording head 74 can be enabled. For this reason, the limit on the head size is eliminated, the head can be freely designed, the number of parts is reduced, and the cost can be reduced.

Also, as shown in FIG. 10 and FIG. 12, the marks 120A, 120B, 120C and 120D have mutually similar shapes in the joining order of the piezoelectric member groups with respect to the marks 122 formed on the flow path plate unit 52 including the diaphragm 30.

When, for example, positioning is done using and mutually superposing marks with congruent shapes, they interfere with the positioning marks that have been previously joined, and joining from the second time on becomes impossible. However, by giving the positioning marks substantially similar shapes, the inner shapes (or outer shapes) of the positioning marks are positioned with respect to the outer shapes (or inner shapes) of the positioning marks, and joining of multiple times from the second time on becomes possible without the positioning marks interfering.

Moreover, the amount of positional displacement between the marks 122 on the flow path plate unit 52 and the marks 120D are measured with a microscope, and on the basis of the measurement result, correction is made in the direction in which the positional displacement amount is cancelled. Thus, regardless of aligning the fixing substrates with respect to the marks of the piezoelectric member group joined immediately before, alignment is substantially done with respect to the marks 122 on the flow path plate unit 52, and the amount of positional displacement of the piezoelectric member groups with respect to the pressure chambers 14 can be reduced.

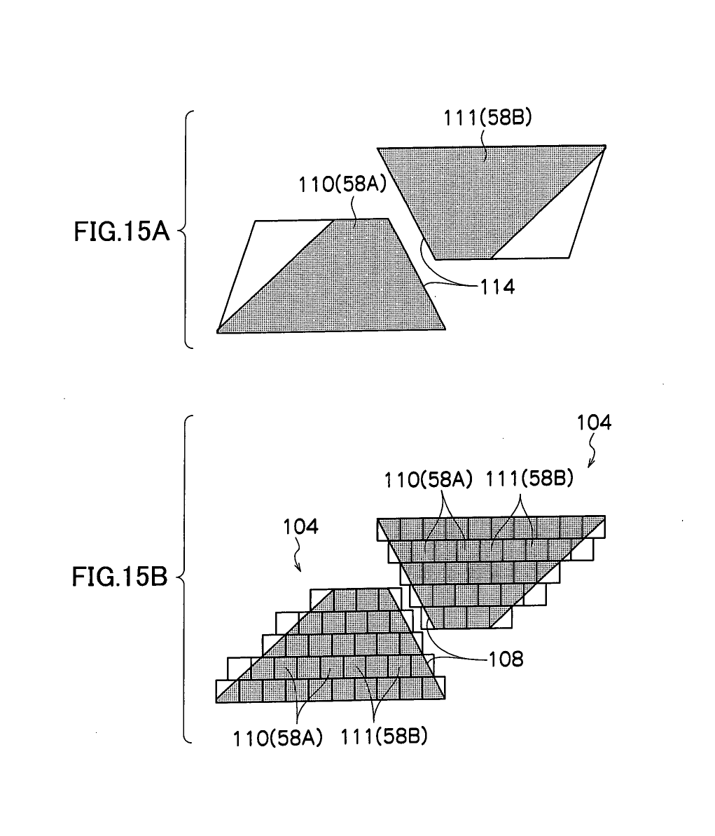

When the piezoelectric member groups 110 and 111 shown in FIG. 15A are formed by respectively different piezoelectric plates 58A and 58B and joined to the diaphragm 30, the difference in the thicknesses of the piezoelectric plates 58A and 58B becomes remarkable at the joint portions 114 where the large-area piezoelectric member group 110 and the piezoelectric member group 111 are joined together.

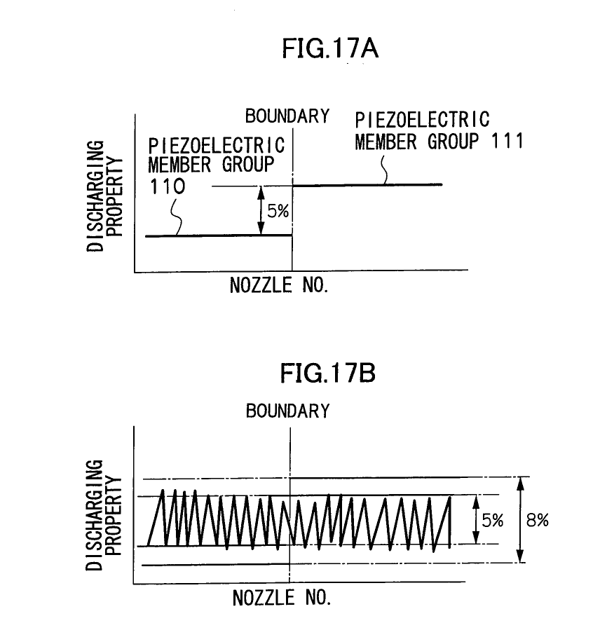

In other words, as shown in FIG. 17A, the boundary becomes remarkable at the joint portions 114 where the piezoelectric member group 110 and the piezoelectric member group 111 are joined together, large variations inside the inkjet recording head 74 can be seen in the discharge characteristics (e.g., the droplet volume) of the ink droplets discharged from the nozzles 10, and poor gradation arises in the image.

In this manner, there are variations in the thicknesses of the piezoelectric plates. But in the present invention, the piezoelectric member groups are classified by the thicknesses of the piezoelectric plates, and those where the error in the thickness is small in the piezoelectric plates are joined together. Thus, variations in the joint portions of the piezoelectric member groups can be reduced.

Moreover, as shown in FIG. 15B and FIG. 16, the large-area piezoelectric body 104 is formed by joining together the plural piezoelectric member groups 110 and 111 (in FIG. 15B, just the piezoelectric member groups 110 and 111 are shown for comparison with FIG. 15A) configured by small areas. By doing this, variations in each of the piezoelectric plates 58A and 58B can be made inconspicuous in comparison to the configuration of FIG. 15A, and as shown in FIG. 17B, variations in the discharge characteristics inside the inkjet recording head 74 can be distributed so as to not impart a boundary at the joint portions 108. For this reason, the effect that it becomes difficult for poor gradation to occur in the image is obtained.

In the case of FIG. 15A, the boundary becomes remarkable in the joint portions 114 of the piezoelectric member group 110 and the piezoelectric member group 111 in the discharge characteristics of the piezoelectric plate 58A and the piezoelectric plate 58B. Thus, if the variations in the discharge characteristics become 5% or greater, gradation ends up clearly appearing in the image.

However, in the case of FIG. 15B, because they can be distributed so as to not impart a boundary at the joint portions 108 of the piezoelectric member group 110 and the piezoelectric member group 111, gradation in the image is not conspicuous if the variations in the discharge characteristics are 8% or less (variations in the thicknesses of the piezoelectric elements are within ±6 μm). For this reason, the yield of the inkjet recording heads 74 can be raised, which leads to a reduction in cost.

Here, the piezoelectric member groups 110 and 111 were classified by the thicknesses of the piezoelectric plates 58. However, the invention is not limited to this because it suffices as long as it can be ensured that the in-head variations in the discharge characteristics do not impart a boundary at the joint portions 108. For example, the electrostatic capacitances of the piezoelectric elements 42 may be measured and the piezoelectric member groups 110 and 111 may be classified according to the measurement result.

Incidentally, although the piezoelectric member groups 110, 111, 112 and 113 are provisionally adhered to the fixing substrates 56A, 56B, 56C and 56D via provisional adhesive tape 130, when for example the piezoelectric member group 110 is joined after the piezoelectric member group 111 as shown in FIG. 18, there is the potential for the end surfaces of the provisional adhesive tape 130 to interfere with the part of the piezoelectric member group 111 already joined to the diaphragm 30 directly or due to the intervention of micro-order microparticles present in a clean room.

In this case, a predetermined clearance must be disposed between adjacent piezoelectric member groups so that the end surfaces of the provisional adhesive tape 130 do not interfere, because there is the potential for the fragile piezoelectric elements 42 to sustain damage that comprises their performance, such as cracks.

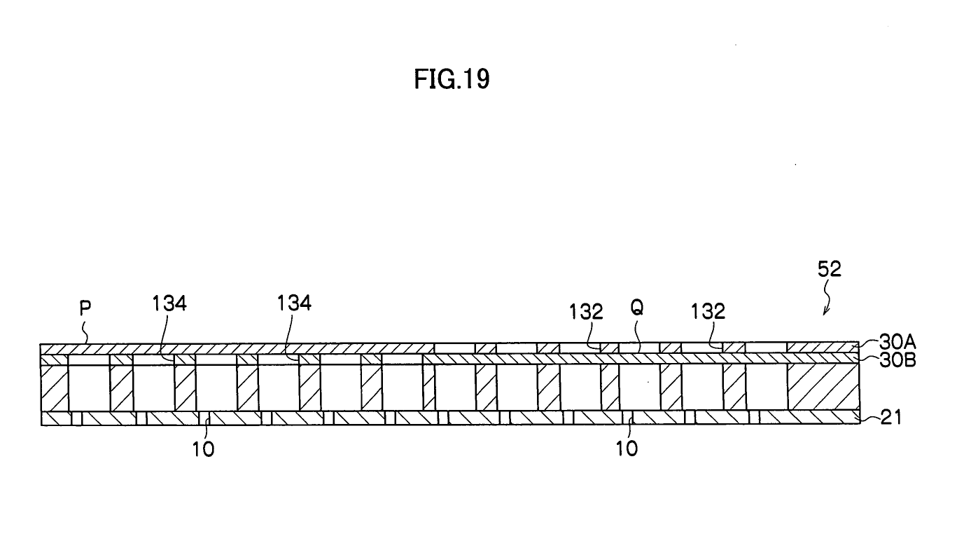

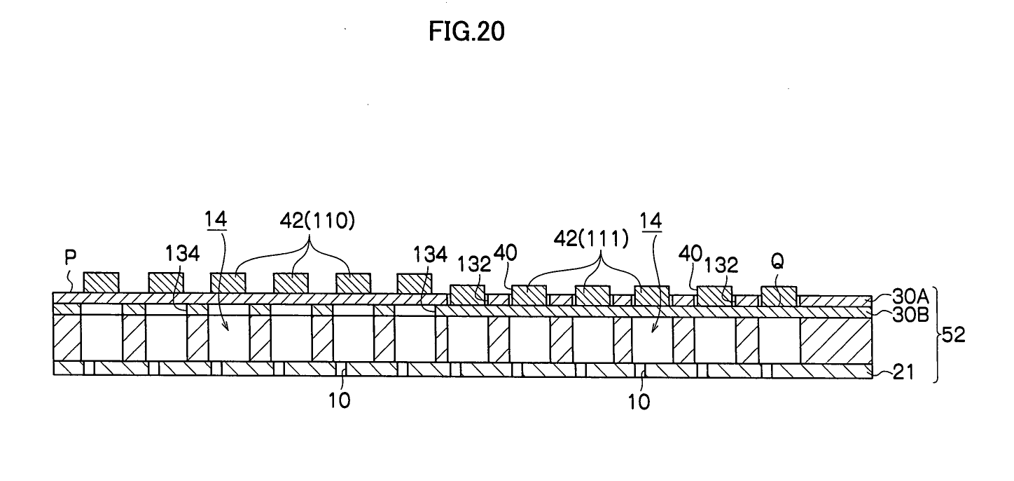

For this reason, as shown in FIG. 19 and FIG. 20 for example, the height of a joint surface P of the piezoelectric member group 110 and the height of a joint surface Q of the piezoelectric member group 111, which groups are mutually adjacent, are changed (for the purpose of convenience, this will be described with the piezoelectric member group 110 and the piezoelectric member group 111).

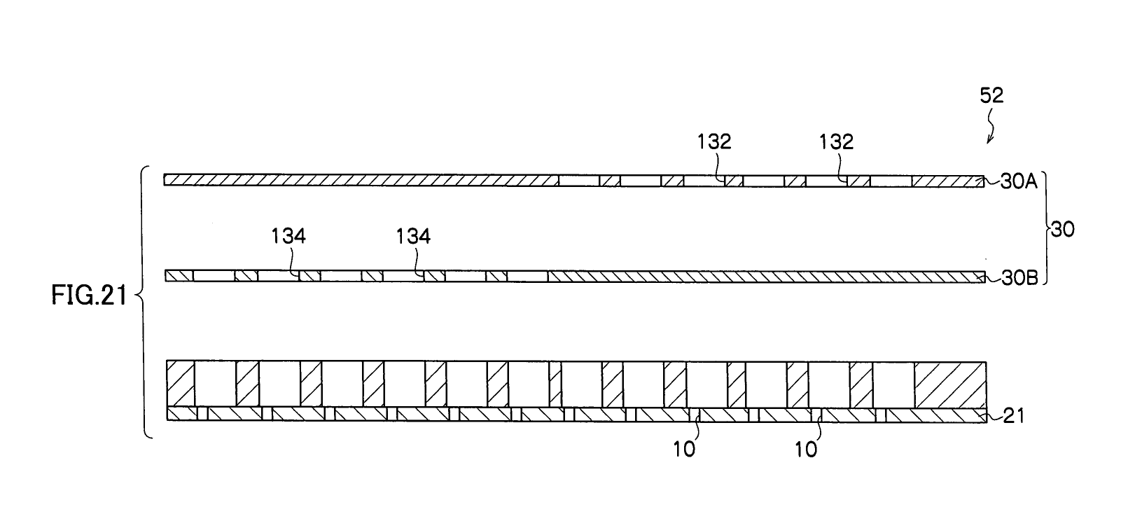

Specifically, as shown in FIG. 21, the diaphragm 30 is configured by two diaphragms 30A and 30B. Through holes 132 and 134 are respectively formed in the diaphragms 30A and 30B to match the pitch of the piezoelectric elements 42 configuring the piezoelectric member group 110 or the piezoelectric member group 111.

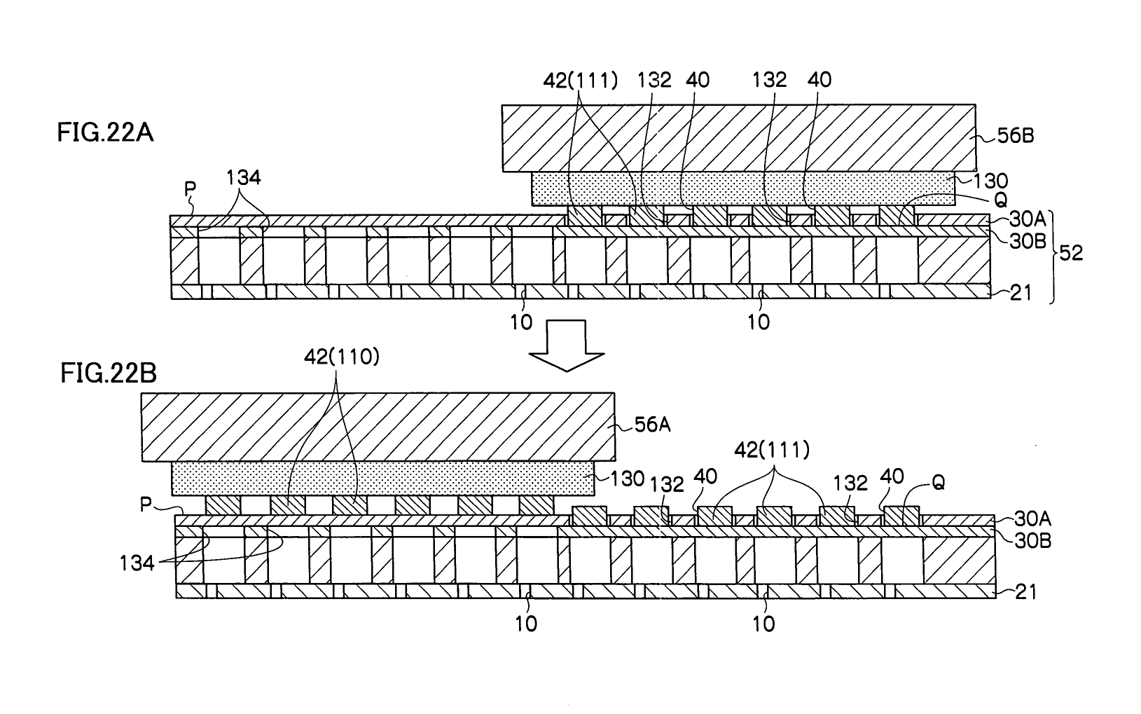

The state in which the diaphragm 30A is superposed on the diaphragm 30B such that the through holes 132 and the through holes 134 are not communicated with each other is the state shown in FIG. 19. In this state, as shown in FIG. 22A, the piezoelectric elements 42 are joined to the upper surface (joint surface Q) of the diaphragm 30B through the through holes 132 to configure the piezoelectric member group 111. Next, as shown in FIG. 22B, the piezoelectric elements 42 are joined to the upper surface (joint surface P) of the diaphragm 30A to configure the piezoelectric member group 110.

By changing the height of the joint surface P of the piezoelectric member group 110 and the height of the joint surface Q of the piezoelectric member group 111 that are mutually adjacent in this manner, there is no longer the potential for the end surfaces of the provisional adhesive tape 130 to interfere with part of the piezoelectric member group 111 when the piezoelectric member group 110 is joined next to the piezoelectric member group 111 already joined to the upper surface of the diaphragm 30B, the clearance between the adjacent piezoelectric member groups 110 and 111 can be reduced, and the nozzles can be arranged in a high density.

Also, the piezoelectric member groups 110 and 111 can be made into smaller pieces, and handling becomes easy. Also, because the piezoelectric member groups 110 and 111 can be made into smaller pieces, the sizes of the piezoelectric member groups 110 and 111 can be further thinned, and improvements in quality and yield can be realized.

Also, by using the two diaphragms 30A and 30B, superposing the diaphragm 30A on the diaphragm 30B such that the through holes 132 and the through holes 134 formed to match the pitch of the piezoelectric elements 42 are not mutually communicated, and disposing the joint surfaces P and Q, the thickness of the diaphragm 30 can be made the same regardless of the heights of the joint surfaces to the diaphragm 30 are different between the adjacent piezoelectric member groups 110 and 111, and the deformation amount of the diaphragm 30 can be made substantially the same.

Here, the diaphragm 30 was configured by the two diaphragms 30A and 30B, and the through holes 132 and the through holes 134 were respectively formed in the diaphragms 30A and 30B, but the invention is not limited to this because it suffices as long as the heights of the joint surfaces P and Q of the piezoelectric member groups 110 and 111 joined to the diaphragm 30 can be changed.

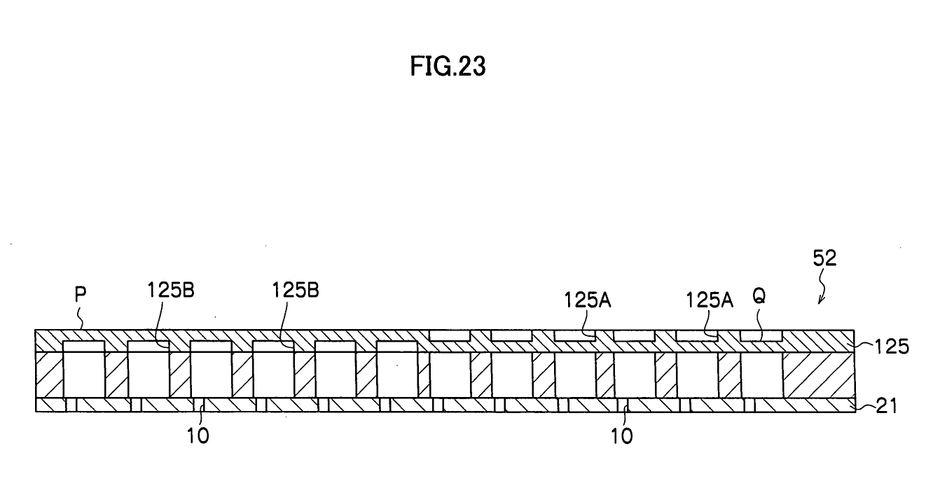

For example, as shown in FIG. 23, one diaphragm 125 may be used, and concave portions 125A may be disposed in the upper surface of the diaphragm 125 and concave portions 125B may be disposed in the undersurface of the diaphragm 125 in correspondence to the through holes 132 and the through holes 134 shown in FIG. 19.

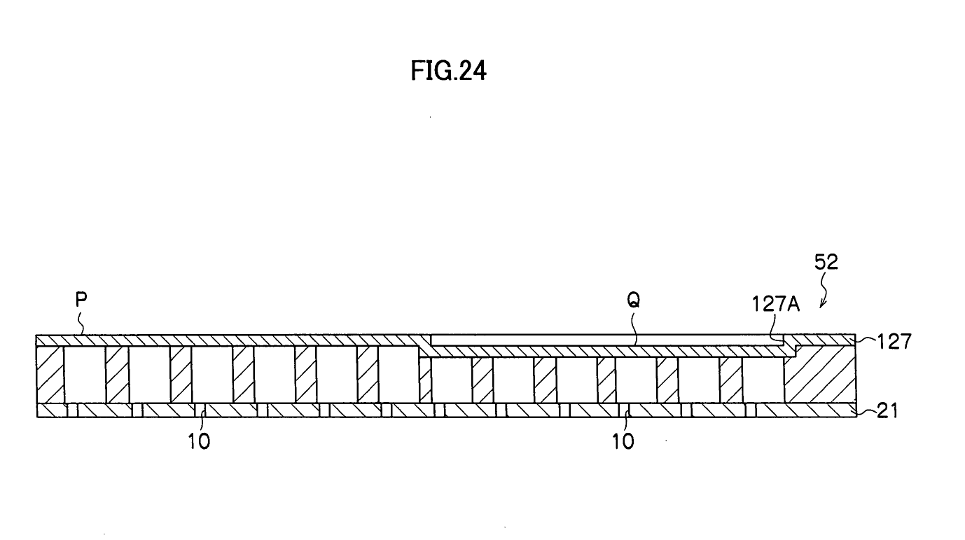

Also, as shown in FIG. 24, one diaphragm 127 may be elastically deformed by pressing so that joint surfaces P and Q with different heights are disposed, but in this case it becomes necessary to also change the shape of the pressure chamber plate 28 (see FIGS. 4A and 4B) to match the shape of the diaphragm 127. Moreover, in FIG. 19 and FIG. 23, the through holes 132 or the concave portions 125A were disposed in correspondence to the piezoelectric elements 42, but one concave portion 127A may also be disposed by a piezoelectric member group unit.

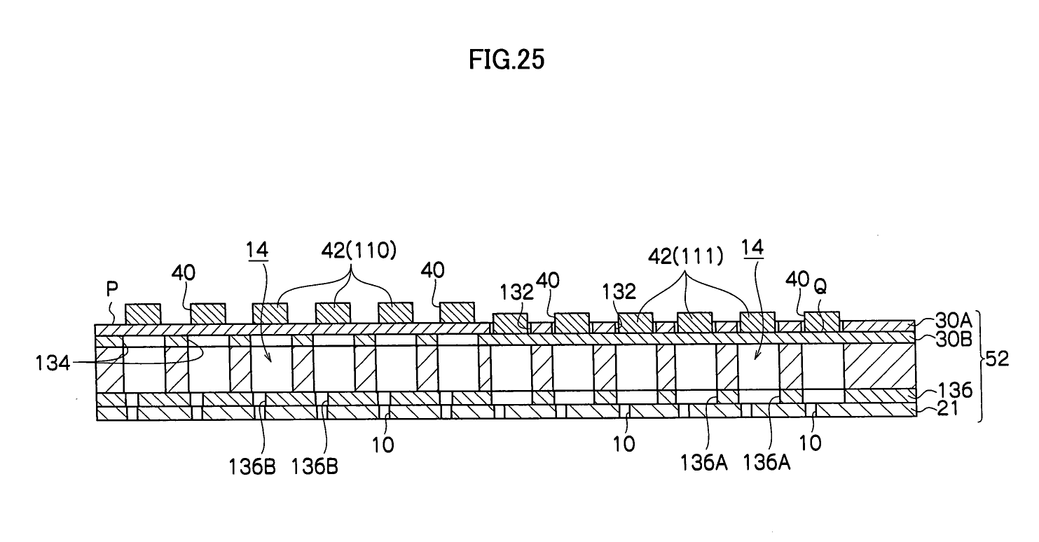

Incidentally, the volumes of the pressure chambers 14 change when the height of the joint surface P of the piezoelectric member group 110 and the height of the joint surface Q of the piezoelectric member group 111 are changed as described above. For this reason, as shown in FIG. 25, an auxiliary pressure chamber plate 136 having a thickness that is substantially the same as that of the diaphragms 30A and 30B may be disposed between the nozzle plate 21 and the ink pool plate 22 (see FIG. 4) to ensure that the volumes of the pressure chambers 14 are the same. Through holes 136A and 136B having different sizes and passing from the pressure chambers 14 to the nozzles 10 are disposed in the auxiliary pressure chamber plate 136 to make the volumes of the pressure chambers 14 the same.

Specifically, the volumes of the pressure chambers 14 in the piezoelectric member group 110 are larger in comparison to those in the piezoelectric member group 111 due to the through holes 134 formed in the diaphragm 30B. For this reason, the sizes of the through holes 136B are made smaller than those of the through holes 136A to cancel the difference in the volumes of the pressure chambers 14 resulting from the through holes 134.

By making the volumes of the pressure chambers 14 substantially the same between the piezoelectric member group 110 and the piezoelectric member group 111 in this manner, the discharge characteristics of the ink droplets discharged from the nozzles 10 are not affected.

In the inkjet recording apparatus 70 of the above-described embodiment, the inkjet recording unit 72 of the respective colors of black, yellow, magenta and cyan is loaded in the carriage 76, ink droplets are selectively discharged from the inkjet recording heads 74 of the respective colors on the basis of image data, and a full-color image is recorded on the recording paper P, but the inkjet recording in the present invention is not limited to recording characters and images on the recording paper P.

That is, the recording medium is not limited to paper, and the liquid that is discharged is not limited to ink. The inkjet recording head 74 pertaining to the present invention can be applied to all kinds of industrially-used liquid droplet discharge apparatus, such as creating display-use color filters by discharging ink droplets onto polymer film or glass and forming bumps for mounting parts by discharging molten solder onto substrates.

Also, in the inkjet recording apparatus 70 of the above-described embodiment, an example was described using a partial width array (PWA) including the main scanning mechanism 82 and the sub-scanning mechanism 94, but the inkjet recording in the present invention is not limited to this. The invention can also be applied to a full width array (FWA) corresponding to paper width. The present invention is rather suited to a full width array requiring one-pass printing because it is effective for realizing a high-density nozzle array.

What is claimed is:

1. A method of manufacturing a liquid droplet discharge head including
nozzles that discharge liquid droplets,
pressure chambers that are communicated with the nozzles and filled with liquid droplets,
a diaphragm that configures part of the pressure chambers, and
piezoelectric member groups that are configured by joining, to the surface of the diaphragm, piezoelectric plates that have groove portions and are processed in a matrix, the piezoelectric member groups including piezoelectric elements that cause the diaphragm to be displaced as a result of a voltage being applied to the piezoelectric elements,
the method comprising:
processing the piezoelectric plates in a matrix to prepare the piezoelectric member groups; and
joining the piezoelectric member groups to the diaphragm in a state where mutual boundaries of the piezoelectric member groups are fitted together and with a predetermined clearance being disposed.

2. The liquid droplet discharge head manufacturing method of claim 1, further comprising classifying the plural piezoelectric member groups on the basis of a predetermined reference and then joining them to the diaphragm.

3. The liquid droplet discharge head manufacturing method of claim 2, wherein the piezoelectric member groups are classified by the thicknesses of the piezoelectric plates.

4. The liquid droplet discharge head manufacturing method of claim 1, wherein positioning marks for positioning the piezoelectric member groups with respect to a positioning reference formed on a flow path plate unit including the diaphragm are patterned together with the piezoelectric member groups on fixing substrates that provisionally fix the piezoelectric member groups.

5. The liquid droplet discharge head manufacturing method of claim 4, wherein when the piezoelectric member groups patterned on the plural fixing substrates are to be respectively joined to the diaphragm, the positioning marks of the piezoelectric member groups to be joined from the second time on have similar shapes with respect to the positioning marks of the piezoelectric member group joined immediately before and are positioned with respect to the positioning marks.

6. The liquid droplet discharge head manufacturing method of claim 4, further comprising
measuring the amount of positional displacement of the positioning marks that have been positioned with respect to the positioning reference, and
after correcting the positional displacement amount, positioning, with respect to the positioning marks, the piezoelectric member group to be joined next.

7. A liquid droplet discharge head comprising:
nozzles that discharge liquid droplets;
pressure chambers that are communicated with the nozzles and filled with liquid droplets;
a diaphragm that configures part of the pressure chambers, and
piezoelectric member groups that are configured by individuating piezoelectric plates in a matrix and joining the piezoelectric plates to the surface of the diaphragm, with the piezoelectric member groups including piezoelectric elements that cause the diaphragm to be displaced as a result of a voltage being applied to the piezoelectric elements;
wherein the liquid droplet discharge head is manufactured by a method including
preparing the piezoelectric member groups where the plural piezoelectric plates have been individuated, and
joining the piezoelectric member groups to the diaphragm in a state where mutual boundaries of the piezoelectric member groups have been fitted together and with a predetermined clearance being disposed.

8. The liquid droplet discharge head of claim 7, wherein the heights of joint surfaces of adjacent piezoelectric member groups are different.

9. The liquid droplet discharge head of claim 8, wherein the diaphragm is configured by an upper diaphragm and a lower diaphragm, through holes are formed in the upper diaphragm and in the lower diaphragm, the upper diaphragm and the lower diaphragm are disposed in a state where they are superposed such that the through holes are not communicated with each other, and the joint surfaces are the upper surface of the upper diaphragm and the upper surface of the lower diaphragm exposed through the through holes in the upper diaphragm.

10. The liquid droplet discharge head of claim 8, wherein a concave portion is formed in the upper surface of the diaphragm, and the joint surfaces are the upper surface of the diaphragm and the bottom surface of the concave portion formed in the upper surface of the diaphragm.

11. The liquid droplet discharge head of claim 10, wherein a concave portion is formed in the undersurface of the diaphragm corresponding to the upper surface of the diaphragm serving as the joint surface.

12. The liquid droplet discharge head of claim 10, wherein an auxiliary plate that makes the volumes of the pressure chambers that change due to the heights of the joint surfaces substantially the same is disposed inside the pressure chambers.

13. A method of manufacturing a liquid droplet discharge head including
nozzles that discharge liquid droplets,
pressure chambers that are communicated with the nozzles and filled with liquid droplets,
a diaphragm that configures part of the pressure chambers, and
piezoelectric member groups that are configured by joining, to the surface of the diaphragm, piezoelectric plates that have groove portions and are processed in a matrix, the piezoelectric member groups including piezoelectric elements that cause the diaphragm to be displaced as a result of a voltage being applied to the piezoelectric elements,
the method comprising:
processing the piezoelectric plates in a matrix including the groove portions and dummy portions to prepare the piezoelectric member groups;
joining the piezoelectric member groups to the diaphragm in a state where mutual boundaries of the piezoelectric member groups have been fitted together and with a predetermined clearance being disposed; and
after joining one of the piezoelectric member groups, measuring its positional displacement amount and, in consideration of correcting the positional displacement amount, joining the next piezoelectric member group.

14. The liquid droplet discharge head manufacturing method of claim 13, further comprising classifying the plural piezoelectric member groups on the basis of a predetermined reference and then joining them to the diaphragm.

15. The liquid droplet discharge head manufacturing method of claim 14, wherein the piezoelectric member groups are classified by the thicknesses of the piezoelectric plates.

16. The liquid droplet discharge head manufacturing method of claim 14, wherein the piezoelectric member groups are classified in accordance with the electrostatic capacitances of the piezoelectric elements.

17. The liquid droplet discharge head manufacturing method of claim 13, wherein positioning marks for positioning the piezoelectric member groups with respect to a positioning reference formed on a flow path plate unit including the diaphragm are patterned together with the piezoelectric member groups on fixing substrates that provisionally fix the piezoelectric member groups.

18. The liquid droplet discharge head manufacturing method of claim 17, wherein when the piezoelectric member groups patterned on the plural fixing substrates are to be respectively joined to the diaphragm, the positioning marks of the piezoelectric member groups to be joined from the second time on have similar shapes with respect to the positioning marks of the piezoelectric member group joined immediately before and are positioned with respect to the positioning marks.

19. The liquid droplet discharge head manufacturing method of claim 17, further comprising
measuring the amount of positional displacement of the positioning marks that have been positioned with respect to the positioning reference, and
after correcting the positional displacement amount, positioning, with respect to the positioning marks, the piezoelectric member group to be joined next.
